(19) United States
(12) Patent Application Publication
(10) Pub. No.: US 2025/0103791 A1
(43) Pub. Date: Mar. 27, 2025

(54) STRUCTURING DEVICE, STRUCTURING METHOD, AND STRUCTURING PROGRAM

(71) Applicant: Hitachi, Ltd., Tokyo (JP)

(72) Inventors: Atsuki YAMAGUCHI, Tokyo (JP); Yasuhiro SOGAWA, Tokyo (JP)

(21) Appl. No.: 18/813,284

(22) Filed: Aug. 23, 2024

(30) Foreign Application Priority Data
Sep. 26, 2023 (JP) 2023-163439

(51) Int. Cl. G06F 40/106; G06V 30/412; G06V 30/416

(52) U.S. Cl. CPC G06F 40/106; G06V 30/412; G06V 30/416

(57) ABSTRACT

A structuring device accesses a processing module pool that stores a plurality of processing modules capable of executing processing based on a feature related to a layout in document data, and a template data pool that stores template data in which two or more processing modules combined according to a dependency relationship among the plurality of processing modules are defined, acquires structuring target document data, extracts specific template data from the template data pool based on a result of a selection input of a feature related to a layout of the structuring target document data, and outputs first structured data in which the structuring target document data is structured by the feature related to the layout, by executing two or more specific processing modules forming the extracted specific template data according to a dependency relationship among the two or more specific processing modules.

### CLAIM OF PRIORITY

The present application claims priority from Japanese patent application No. 2023-163439 filed on Sep. 26, 2023, the content of which is hereby incorporated by reference into this application.

### BACKGROUND OF THE INVENTION

### 1. Field of the Invention

The present invention relates to a structuring device, a structuring method, and a structuring program for structuring a structuring target.

### 2. Description of Related Art

By structuring an atypical document, information extraction and information search from a document can be performed with high accuracy, and the opportunity of information to be obtained is improved. For example, a case in which an abstract is extracted from an academic paper and used in a search system is found by an academic document search service such as Google Scholar or Semantic Scholar. In addition, although a large amount of text data is necessary for training of a large-scale language model, it is possible to construct a model with good performance with a smaller amount of data by using structured data.

PTL 1 discloses a related technique for structuring an atypical document. PTL 1 discloses “to provide a deep learning-based method of extracting structured information from an atypical document, which is implemented by at least one processor of a computing device”. PTL 1 also describes “the deep learning-based method of extracting the structured information from the atypical document includes: a step of receiving an input image; and a step of converting, into the structured information, a token sequence indicating a structure of the input image from the input image using a deep learning-based encoder-decoder model”.

PTL 2 describes “defining a structured document that includes a hierarchy of structural elements constructed by analyzing a non-structured document”. PTL 2 also describes “the basic elements of the non-structured document are used for defining the structured document, and the various geographical attributes of the non-structured document are identified. The identified geographical attributes and the other attributes of the basic elements are used for defining the related basic elements (for example, words, paragraphs, connection graphs) and the structural elements such as charts, guides, and margins, and for defining the reading flow of the basic elements and the structural elements”.

PTL 3 describes “a method of converting content information from a non-structured data format to a structured data format”. PTL 3 also describes “the conversion module converts the content information from the non-structured data format to the structured data format according to a rule”.

PTL 4 describes “to easily create a structured document matched with a logical structure of an individual document by executing conversion from a non-structured document to a structured document by the use of a rule directly created from previously set logical structure definition”.

Attempts for structuring non-structured document data have been widely made. For example, the technique described in PTL 1 discloses units for extracting the structured information from the atypical document to the end-to-end by deep learning. In addition, the technique described in PTL 2 structures an atypical document by implementing a predetermined processing flow based on a rule-based approach. In the technique described in PTL 3, the method of converting input data from the non-structured data format to the structured data format is provided. A granularity of information to be displayed can be changed depending on a type of a display client. The technique described in PTL 4 discloses units for converting the non-structured document into structured data by processing according to a predetermined pattern.

### CITATION LIST

### Patent Literature

PTL 1: JP2023-080045A
PTL 2: JP2016-006661A
PTL 3: JP2017-529622A
PTL 4: JPH09-069101A

### SUMMARY OF THE INVENTION

In the related art, since it is difficult to perform structuring processing according to a difference in layouts of input documents, the structuring is not necessarily performed with low noise. The structuring from a single column document is assumed as an example. However, actually, when the input document is a double column, structuring of a sentence straddling the column is not assumed, and thus noise is generated.

An object of the invention is to improve accuracy of structuring of document data.

A structuring device as one aspect of the invention disclosed in the present application includes: a processor configured to execute a program; and a storage device configured to store the program. A processing module pool that stores a plurality of processing modules capable of executing processing based on a feature related to a layout in document data, and a template data pool that stores template data in which two or more processing modules combined according to a dependency relationship among the plurality of processing modules are defined, are accessible. The processor executes acquisition processing of acquiring structuring target document data, extraction processing of extracting specific template data from the template data pool based on a result of a selection input of a feature related to a layout of the structuring target document data acquired by the acquisition processing, and structuring processing of outputting first structured data in which the structuring target document data is structured by the feature related to the layout, by executing two or more specific processing modules forming the specific template data extracted by the extraction processing according to a dependency relationship among the two or more specific processing modules.

According to a representative embodiment of the invention, it is possible to improve the accuracy of the structuring of the document data. Problems, configurations, and effects other than those described above will be clarified by descriptions of the following embodiments.

### BRIEF DESCRIPTION OF THE DRAWINGS

FIG. 1 is a block diagram showing a functional configuration example of a structuring device according to Embodiment 1.

FIG. 2 is a diagram showing an example of structuring target document data shown in FIG. 1.

FIG. 3 is a flowchart showing an example of a data loading processing procedure performed by a data loading module.

FIG. 4 is a flowchart showing an example of a row extraction processing procedure performed by a row extraction module.

FIG. 5 is a flowchart showing an example of a foot note extraction processing procedure performed by a foot note extraction module.

FIG. 6 is a flowchart showing an example of a chart extraction processing procedure performed by a chart extraction module.

FIG. 7 is a flowchart showing an example of a caption extraction processing procedure performed by a caption extraction module.

FIG. 8 is a flowchart showing an example of a formula extraction processing procedure performed by a formula extraction module.

FIG. 9 is a flowchart showing an example of an auxiliary information extraction processing procedure performed by an auxiliary information extraction module.

FIG. 10 is a flowchart showing an example of a paragraph extraction processing procedure performed by a paragraph extraction module.

FIG. 11 is a flowchart showing an example of a chapter structure detection processing procedure performed by a chapter structure detection module.

FIG. 12 is a flowchart showing an example of a column coupling processing procedure performed by a column coupling module.

FIG. 13 is a flowchart showing an example of a page coupling processing procedure performed by a page coupling module.

FIG. 14 is a flowchart showing an example of an output processing procedure performed by an output module.

FIG. 15 is a flowchart showing a detailed processing procedure example of chapter structure creation processing (step S1403) performed by the output module.

FIG. 16 is a diagram showing an example of structured data.

FIG. 17 is a diagram showing an example of dependency relationship data in which a dependency relationship is defined.

FIG. 18 is a diagram showing an example of template data.

FIG. 19 is a diagram showing an example of setting data.

FIG. 20 is a flowchart showing an example of an extraction processing procedure of the template data.

FIG. 21 is a diagram showing an example 1 of a setting execution screen of the structuring device according to Embodiment 1.

FIG. 22 is a diagram showing an example 2 of the setting execution screen of the structuring device according to Embodiment 1.

FIG. 23 is a flowchart showing an example of a confirmation processing procedure of a dependency relationship between processing modules by the structuring device according to Embodiment 1.

FIG. 24 is a block diagram showing a hardware configuration example of the structuring device according to Embodiment 1.

FIG. 25 is a block diagram showing a functional configuration example 1 of a structuring device according to Embodiment 2.

FIG. 26 is a block diagram showing a functional configuration example 2 of the structuring device according to Embodiment 2.

FIG. 27 is a diagram showing an example 1 of a setting execution screen according to Embodiment 2.

FIG. 28 is a diagram showing an example 2 of the setting execution screen according to Embodiment 2.

### DESCRIPTION OF EMBODIMENTS

### Embodiment 1

### Functional Configuration of Structuring Device

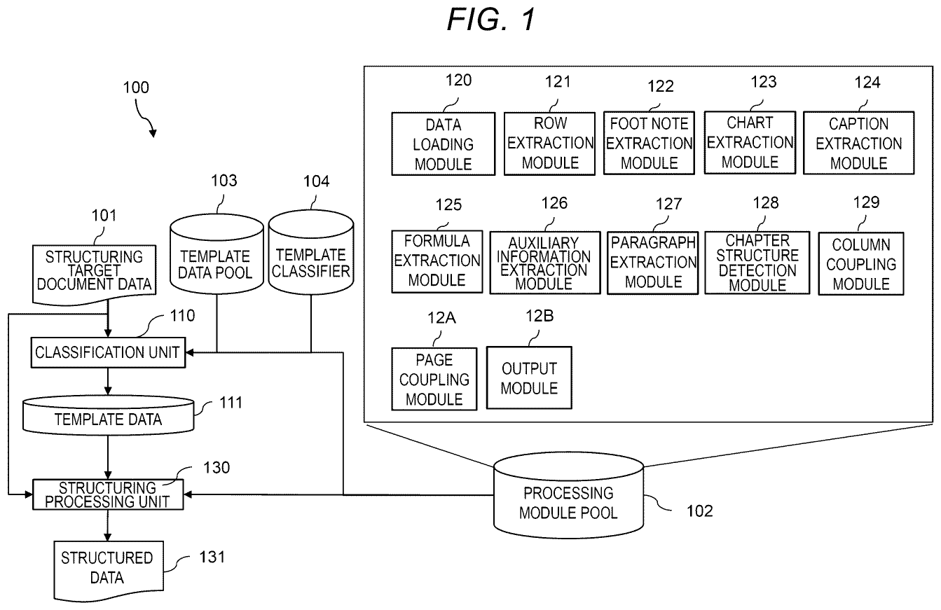

FIG. 1 is a block diagram showing a functional configuration example of a structuring device according to Embodiment 1. A structuring device 100 acquires, as input data, a structuring target document data 101, a processing module pool 102, a template data pool 103, and a template classifier 104. The structuring device 100 includes a classification unit 110 and a structuring processing unit 130.

The processing module pool 102 is a data region that stores a plurality of processing modules for structuring the structuring target document data 101. The processing module pool 102 includes the plurality of processing modules, specifically, for example, a data loading module 120, a row extraction module 121, a foot note extraction module 122, a chart extraction module 123, a caption extraction module 124, a formula extraction module 125, an auxiliary information extraction module 126, a paragraph extraction module 127, a chapter structure detection module 128, a column coupling module 129, a page coupling module 12A, and an output module 12B.

When the data loading module 120 to the output module 12B are not distinguished, they are referred to as processing modules 12#. Each of the processing modules 12# is a software module that executes unique processing.

The template data pool 103 holds one or more pieces of template data satisfying a dependency relationship among a plurality of the processing modules 12#. The template data includes the plurality of processing modules 12# in the processing module pool 102, and is implemented according to an execution order of the plurality of processing modules 12#.

The classification unit 110 classifies the template data pool 103 using the template classifier 104, and outputs template data 111 suitable for the layout of the structuring target document data 101.

The structuring processing unit 130 receives the structuring target document data 101, extracts a processing module group defined by the template data 111 from the processing module pool 102, and executes the extracted processing module group in an order defined by the template data 111. The structuring processing unit 130 outputs structured data 131.

The structuring device 100 can handle any language, and in Embodiment 1, an example of handling English will be described.

### Structuring Target Document Data 101

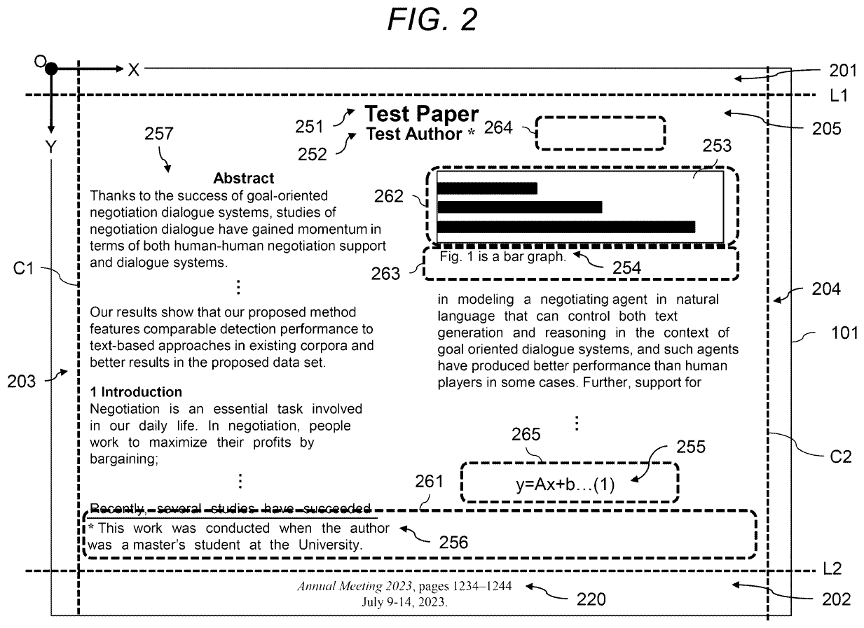

FIG. 2 is a diagram showing an example of the structuring target document data 101 shown in FIG. 1. The structuring target document data 101 may be document data in any domain. In Embodiment 1, for convenience, an example of handling academic papers will be described. The structuring target document data 101 includes document data to be converted into structured document data. Although a data format of the document data is not limited, in Embodiment 1, for convenience, the structuring target document data 101 is a document in a portable document format (PDF).

In FIG. 2, only a leading page of the structuring target document data 101 is shown, but there are two or more pages. An upper left apex of each page of the structuring target document data 101 is defined as a coordinate origin O, a width direction of the page is defined as an X-axis, and a height direction of the page is defined as a Y-axis.

A region above a first row line L1, that is, a region where a Y-coordinate value is equal to or smaller than a Y-coordinate value of the first row line L1, is referred to as a header region 201. A region below a second row line L2, that is, a region where a Y-coordinate value is equal to or larger than the Y-coordinate value of the first row line L1, is referred to as a footer region 202. In the footer region 202, for example, a character string 220 indicating disclosure information of the structuring target document data 101 is described.

A region on a left side of a first column line C1, that is, a region where an X-coordinate value is equal to or smaller than a coordinate value of the first column line C1, is referred to as a left margin region 203. A region on a right side of a second column line C2, that is, a region where an X-coordinate value is equal to or larger than a coordinate value of the second column line C2, is referred to as a right margin region 204.

A region surrounded by the first row line L1, the second row line L2, the first column line C1, and the second column line C2 is referred to as a body text region 205. Data in the body text region 205 is referred to as a body text. Hereinafter, the body text region 205 is referred to as a body text 205 for convenience. In the body text 205, a character string 251 described as “Test Paper” is a heading, and a character string 252 described as “Test Author” is an author name.

In the body text 205, a bar graph 253 is a chart, and “FIG. 1 is a bar graph.”, which is a character string 254 below the bar graph 253, is a caption for the bar graph 253.

In the body text 205, a character string 255 indicating “y=Ax+B . . . (1)” is a formula. A character string 256, which is described as “* This work was conducted when the author was a master's student at the University.” is a foot note.

A character string 257 starting from “Abstract” other than the character strings 251, 252, and 254 to 256 in the body text 205 is a body text character string. The character string 257 is described in a double column.

### Processing Module 12#

Referring back to FIG. 1, each processing module 12# is specifically described.

### Data Loading Module 120

The data loading module 120 is, for example, a module that executes data loading of the structuring target document data 101. The data loading module 120 extracts information (reading order, token, meta information, object) necessary for structuring from the structuring target document data 101 for each page of the structuring target document data 101.

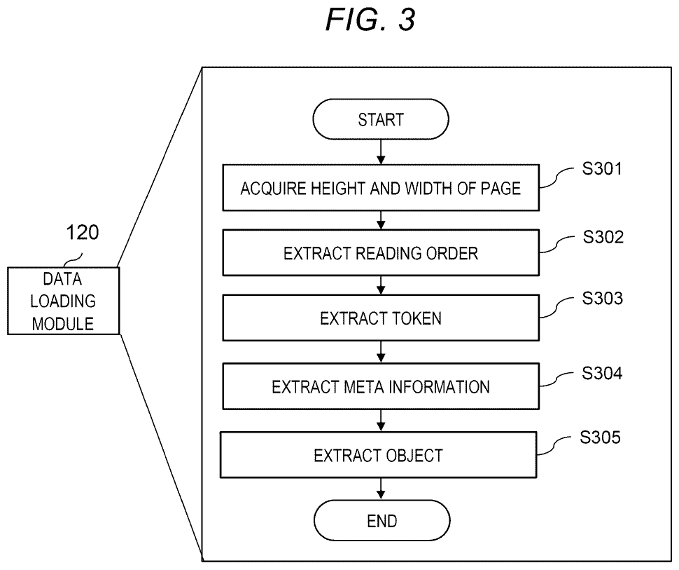

FIG. 3 is a flowchart showing an example of a data loading processing procedure performed by the data loading module 120.

### Step S301

The data loading module 120 acquires a height and a width of the page of the structuring target document data 101. The height of the page is a length of the page in a Y-axis direction, and the width of the page is a length of the page in the X-axis direction.

### Step S302

The data loading module 120 extracts a reading order of tokens. The token is a character string indicating a processing unit, and is, for example, a word. When the reading order of the words is the structuring target document data 101 embedded as metadata, the data loading module 120 determines the metadata in the reading order.

When the reading order is not embedded in the structuring target document data 101, the data loading module 120 estimates the reading order. The data loading module 120 can execute estimation of the reading order by a machine learning model such as a LayoutReader.

In the case of the structuring target document data 101 shown in FIG. 2, the data loading module 120 extracts the reading order of the tokens in the character strings 220, 251, 252, and 254 to 257.

### Step S303

The data loading module 120 extracts the tokens in the structuring target document data 101 according to the reading order determined or estimated in step S302. The data loading module 120 stores, for each page, a token string in the page as an instance of the page in the reading order.

In the case of the structuring target document data 101 shown in FIG. 2, the data loading module 120 extracts the tokens in the character strings 220, 251, 252, and 254 to 257, and stores the tokens as instances of the first page.

### Step S304

The data loading module 120 extracts meta information of each token. The meta information is associated with the token in the structuring target document data 101 as a part of the metadata. The meta information includes, for example, a font size of characters that form the token, a font name of the characters, and coordinate values of the token or the characters that form the token. When meta information is not associated with the structuring target document data 101 as a part of the metadata, the structuring device 100 applies default meta information set in advance. The data loading module 120 associates the meta information in the page with the token and stores the meta information as an instance of the page for each page.

### Step S305

The data loading module 120 extracts an object such as a line, a drawing, and an image from the structuring target document data 101. The data loading module 120 associates the object with a page number, and stores the object in the page as an instance of the object in the instance of the page for each page. Accordingly, data loading processing performed by the data loading module 120 ends.

In the case of the structuring target document data 101 shown in FIG. 2, the data loading module 120 extracts the bar graph 253, and stores the bar graph 253 as an instance of the first page.

### Row Extraction Module 121

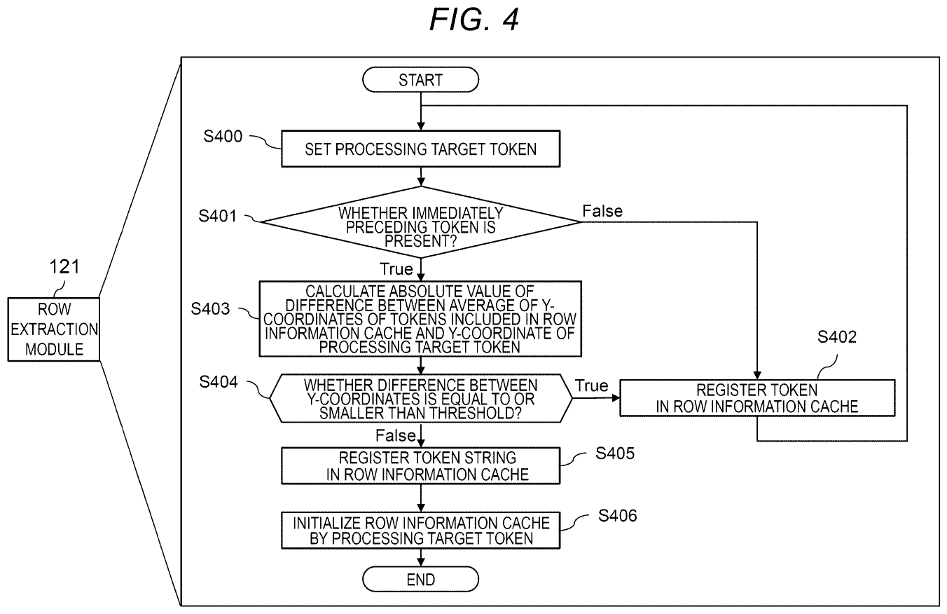

The row extraction module 121 refers to a layout of the token in the structuring target document data 101 (that is, coordinate values of the token), specifies a row of the structuring target document data 101, and extracts a row element of the specified row from the instance of the page. The row element is a token string arranged in a row. The row element is, for example, a token string of each row in the character strings 220, 251, 252, and 254 to 257. The row extraction module 121 is executed according to, for example, an algorithm shown in a flowchart in FIG. 4.

FIG. 4 is a flowchart showing an example of a row extraction processing procedure performed by the row extraction module 121. The row extraction module 121 uses a row information cache. In the row information cache, tokens in the same row are held by the execution of the row extraction module 121.

### Step S400

The row extraction module 121 sets a processing target token in the instance of the page. The processing target token is a token to be extracted. In an initial state, the processing target token is a leading token in the reading order. In the case of the structuring target document data 101 shown in FIG. 2, “Test” of the character string 251 is the leading token. When the processing proceeds from step S403, the token (“Paper”) in the next reading order of the processing target token (“Test”) at that time registered in the row information cache in step S403 is set as a new processing target token.

### Step S401

The row extraction module 121 determines whether a token immediately preceding the processing target token in the reading order is present. If step S401 is true (step S401: True), the processing proceeds to step S403. If step S401 is false (step S401: False), the processing target token is the leading token in the reading order, and therefore the processing proceeds to step S402.

### Step S402

The row extraction module 121 stores the processing target token in the row information cache and returns to step S400. Specifically, for example, the row extraction module 121 registers the leading token “Test” in the character string 251 in the row information cache.

### Step S403

The row extraction module 121 calculates an absolute value of a difference between a mean value of Y-coordinate values (coordinate values in a column direction) of the tokens included in the row information cache and a Y-coordinate value of the processing target token. In step S402, one or more tokens are held in the row information cache, and the row extraction module 121 calculates a mean value of Y-coordinate values of one or more tokens.
Example 403-1: For example, the processing target token is “Paper” of the character string 251. The row information cache stores “Test” as a token. The row extraction module 121 calculates an absolute value of a difference between a Y-coordinate value of “Test” in the row information cache and a Y-coordinate value of “Paper” which is the processing target token.
Example 403-2: For example, the processing target token is “Test” of the character string 252. The row information cache stores “Test” and “Paper” as tokens. The row extraction module 121 calculates an absolute value of a difference between a mean value of the Y-coordinate value of “Test” and the Y-coordinate value of “Paper” in the row information cache and the Y-coordinate value of “Test” of the character string 252 which is the processing target token.

### Step S404

The row extraction module 121 determines whether the absolute value of the difference calculated in step S403 is equal to or smaller than a threshold. Although the threshold can be set by a user, since a coordinate system in Embodiment 1 is standardized, a setting value assumed on the structuring device 100 side may be used as a default value of the threshold.

If step S404 is true (step S404: True), the token included in the row information cache and the processing target token can be regarded as belonging to the same row, and therefore the processing proceeds to step S402. For example, the case of the above example 403-1 corresponds. In this case, in step S402, the row extraction module 121 registers “Paper”, which is the processing target token, in the row information cache.

If step S404 is false (step S404: False), since it is determined that the processing target token is not included in the same row as the token included in the row information cache, the processing proceeds to step S405. For example, the case of the above example 403-2 corresponds.

### Step S405

The row extraction module 121 registers the token string in the row information cache as a row element, and as an instance of a row in the instance of the page. For example, in the case of the above example 403-2, since “Test” and “Paper” are stored as tokens in the row information cache, the row extraction module 121 registers “Test” and “Paper”, which are token strings, as the instance of the row in the instance of the page.

### Step S406

The row extraction module 121 initializes the row information cache by a current processing target token. That is, the current processing target token is held in the row information cache as a leading token of the next row. For example, in the case of the above example 403-2, the row extraction module 121 deletes the token “Test” other than “Paper” of the character string 251 which is the current processing target token among “Test” and “Paper” which are token strings.

As described above, by applying row extraction processing to the structuring target document data 101 after being applied to the data loading module 120, all row elements included in the structuring target document data 101 can be extracted from the instance of the page. Accordingly, the row extraction processing performed by the row extraction module 121 ends.

### Foot Note Extraction Module 122

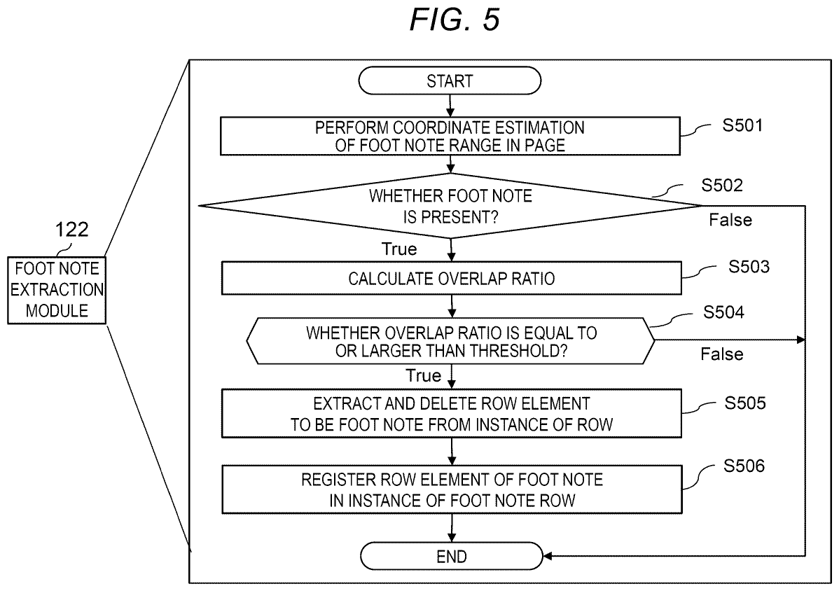

The foot note extraction module 122 extracts a foot note from the row element in the instance of the row. In the instance of the row, a token string is stored for each row. The foot note is a character string indicating a note given to a lower part of the page. The foot note extraction module 122 is executed in page units according to, for example, an algorithm shown in a flowchart in FIG. 5.

FIG. 5 is a flowchart showing an example of a foot note extraction processing procedure performed by the foot note extraction module 122.

### Step S501

The foot note extraction module 122 attempts to perform coordinate estimation of a foot note range in a processing target page of the structuring target document data 101. The coordinate estimation can be implemented, for example, by using an object detection model such as X101 trained from a DocBank data set.

### Step S502

As a result of attempting to perform the coordinate estimation in step S501, the foot note extraction module 122 determines whether a coordinate region estimated to be a foot note (hereinafter, foot note estimation region) is present in the page of the structuring target document data 101. If step S502 is false (step S502: False), foot note extraction processing performed by the foot note extraction module 122 in the page ends, and when there is a next page, the foot note extraction module 122 executes the foot note extraction processing using the next page as a processing target page. If step S502 is true (step S502: True), the processing proceeds to step S503.

### Step S503

The foot note extraction module 122 calculates an overlap ratio between the foot note estimation region and the row element in the instance of the row. A foot note estimation region 261 is estimated in FIG. 2 by step S502.
Example 503-1: For example, a row element for which the overlap ratio is to be calculated is a token string “Recently, several studies have succeeded” which is the lowermost row on the left column in the character string 257. In this case, an overlap ratio between the foot note estimation region 261 and the row element is calculated as 40%.
Example 503-2: For example, a row element for which the overlap ratio is to be calculated is a token string “* This work was conducted when the author” which is a character string in the upper row of the character string 256. In this case, an overlap ratio between the foot note estimation region 261 and the row element is 100%. Similarly, the overlap ratio between the foot note estimation region 261 and a token string “was a master's student at the University.” in the lower row of the character string 256 is 100%.

### Step S504

The foot note extraction module 122 determines whether the overlap ratio calculated in step S503 is equal to or larger than a threshold. Although the threshold can be set by the user, since the overlap ratio is calculated in a range of 0% to 100%, a setting value assumed on the structuring device 100 side may be used as a default value of the threshold. If step S504 is false (step S504: False), since it is considered that there is no row element to be extracted as a foot note, the foot note extraction processing performed by the foot note extraction module 122 in the page ends, and when there is a next page, the foot note extraction module 122 executes the foot note extraction processing using the next page as a processing target page. If step S504 is true (step S504: True), the processing proceeds to step S505.

In the case of the above example 503-1, when the threshold is, for example, 60%, it is determined that the token string “Recently, several studies have succeeded”, which is the row element, is not a foot note, and step S504 is false (step S504: False).

On the other hand, in the case of the above example 503-2, it is determined that each of the token strings in the upper row and the lower row of the character string 256, which is the row element, is a foot note, and step S504 is true (step S504: True).

### Step S505

The foot note extraction module 122 extracts the row element to be a foot note from the instance of the row, and deletes the row element from the instance of the row. In the case of the above example 503-2, the foot note extraction module 122 deletes each of the token strings in the upper row and the lower row of the character string 256, which is the row element, from the instance of the row.

### Step S506

The foot note extraction module 122 associates the row element extracted in step S505 with a page number and a row number, and registers the row element as the row element of the foot note in an instance of a foot note row. Thereafter, the foot note extraction processing performed by the foot note extraction module 122 in the page ends, and when there is a next page, the foot note extraction module 122 executes the foot note extraction processing using the next page as a processing target page.

In the case of the above example 503-2, the foot note extraction module 122 associates each of the token strings in the upper row and the lower row of the character string 256, which is the row element, with the page number and the row number, and registers the token strings as the row element of the foot note in the instance of the foot note row.

### Chart Extraction Module 123

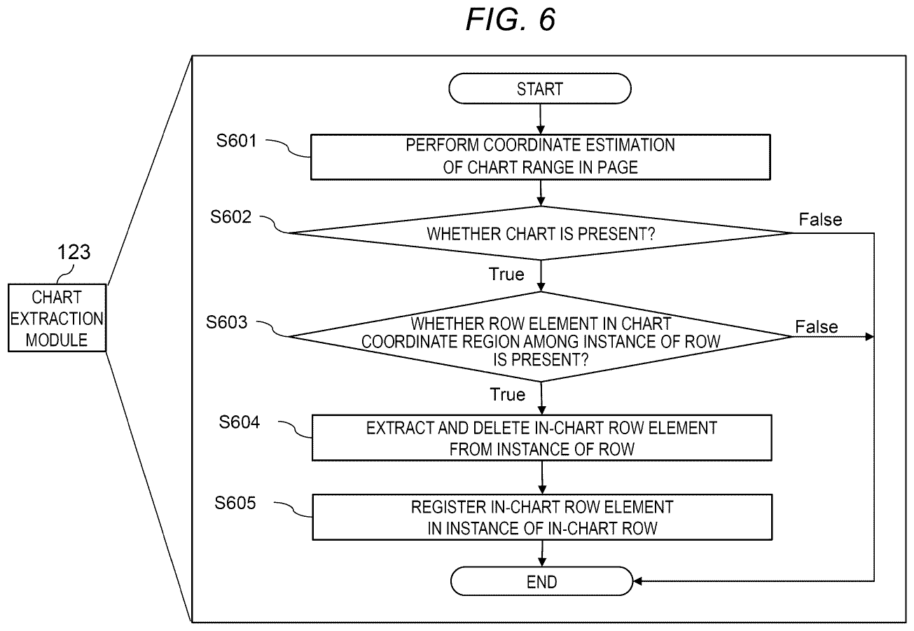

The chart extraction module 123 extracts a row element included in a chart (hereinafter, in-chart row element) of the structuring target document data 101 from the instance of the row. The chart extraction module 123 is executed in page units according to, for example, an algorithm shown in a flowchart in FIG. 6.

FIG. 6 is a flowchart showing an example of a chart extraction processing procedure performed by the chart extraction module 123.

### Step S601

The chart extraction module 123 attempts to perform coordinate estimation of a chart range in a processing target page of the structuring target document data 101. The coordinate estimation can be implemented by using an object detection model such as X101 trained from a DocBank data set, similarly to the foot note extraction module 122 in FIG. 5. Further, the coordinate estimation can also be implemented by an object detection model such as X101 trained from a Publaynet or TableBank data set.

### Step S602

As a result of attempting to perform the coordinate estimation in step S601, the chart extraction module 123 determines whether a coordinate region estimated to be a chart (hereinafter, chart estimation region) is present. If step S602 is false (step S602: False), chart extraction processing performed by the chart extraction module 123 in the page ends, and when there is a next page, the chart extraction module 123 executes the chart extraction processing using the next page as a processing target page. If step S602 is true (step S602: True), the processing proceeds to step S603.

### Step S603

The chart extraction module 123 determines whether a row element belonging to the chart estimation region among the row element of the instance of the row is present. If step S603 is false (step S603: False), since there is no row element to be deleted from the instance of the row, the chart extraction processing performed by the chart extraction module 123 in the page ends, and when there is a next page, the chart extraction module 123 executes the chart extraction processing using the next page as a processing target page. If step S603 is true (step S603: True), the processing proceeds to step 604.

### Step S604

The chart extraction module 123 extracts the corresponding row element from the instance of the row, and deletes the corresponding row element from the instance of the row.

### Step S605

The chart extraction module 123 registers the row element extracted in step S604 as the in-chart row element in an instance of an in-chart row. Thereafter, the chart extraction processing performed by the chart extraction module 123 in the page ends, and when there is a next page, the chart extraction module 123 executes the chart extraction processing using the next page as a processing target page.

In the example of FIG. 2, since no token is present in the bar graph 253, nothing is registered in the instance of the in-chart row. However, when a token is present in the bar graph 253 (for example, scale numerical values are axis descriptions and the like), the in-chart row element is registered in the instance of the in-chart row.

### Caption Extraction Module 124

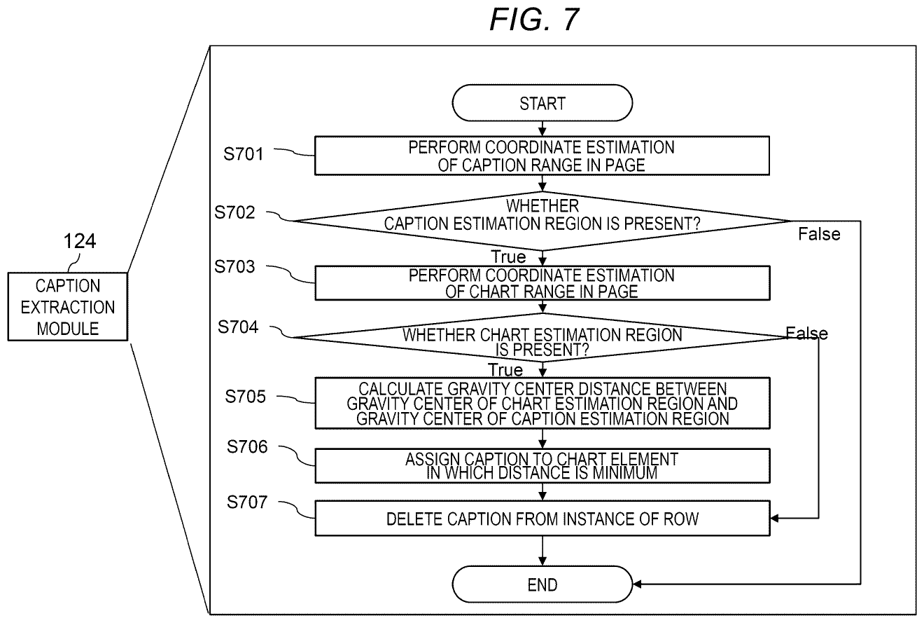

The caption extraction module 124 extracts a row element corresponding to a caption of a chart. The caption extraction module 124 is executed in page units according to, for example, an algorithm shown in a flowchart in FIG. 7.

FIG. 7 is a flowchart showing an example of a caption extraction processing procedure performed by the caption extraction module 124.

### Step S701

The caption extraction module 124 attempts to perform coordinate estimation of a range including the caption in the processing target page of the structuring target document data 101. The coordinate estimation can be implemented by using an object detection model such as X101 trained from a DocBank or Publaynet data set, similarly to the modules in FIGS. 5 and 6.

### Step S702

As a result of attempting to perform the coordinate estimation in step S701, the caption extraction module 124 determines whether a coordinate region estimated to be a caption (hereinafter, caption estimation region) is present. If step S702 is false (step S702: False), caption extraction processing performed by the caption extraction module 124 in the page ends, and when there is a next page, the caption extraction module 124 executes the caption extraction processing using the next page as a processing target page. If step S702 is true (step S702: True), the processing proceeds to step S703.

In the example of FIG. 2, two caption estimation regions 263 and 264 are estimated.

### Step S703

The caption extraction module 124 attempts to perform the coordinate estimation of the chart range in the processing target page, similarly to the chart extraction module 123. In the example of FIG. 2, a chart estimation region 262 is estimated.

### Step S704

As a result of attempting to perform the coordinate estimation in step S703, the caption extraction module 124 determines whether a chart estimation region is present. If step S704 is true (step S704: True), the processing proceeds to step S705. If step S704 is false (step S704: False), the processing proceeds to step S707.

### Step S705

The caption extraction module 124 uses the row element in the caption estimation region as a caption, and calculates a gravity center distance between a gravity center of the chart estimation region and a gravity center of the caption estimation region. In the example of FIG. 2, the caption extraction module 124 calculates a gravity center distance between a gravity center of the chart estimation region 262 and a gravity center of the caption estimation region 263. The caption extraction module 124 calculates a gravity center distance between the gravity center of the chart estimation region 262 and a gravity center of the caption estimation region 264.

### Step S706

The caption extraction module 124 assigns, to each of the in-chart row elements in the instance of the in-chart row, a row element in the caption estimation region, in which the gravity center distance from the chart estimation region is minimum, as a caption. In the example of FIG. 2, the caption estimation region in which the gravity center distance from the chart estimation region 262 is minimum is the caption estimation region 263. Accordingly, the caption extraction module 124 associates the token string “FIG. 1 is a bar graph.”, which is a row element in the caption estimation region 263 in which the gravity center distance from the chart estimation region 262 is minimum, with each of the in-chart row elements, and stores the token string in the instance of the in-chart row.

### Step S707

The caption extraction module 124 deletes the caption from the instance of the row. Thereafter, the caption extraction processing performed by the caption extraction module 124 in the page ends, and when there is a next page, the caption extraction module 124 executes the caption extraction processing using the next page as a processing target page.

The caption extraction module 124 deletes the row element “FIG. 1 is a bar graph.” which is the caption from the instance of the row.

### Formula Extraction Module 125

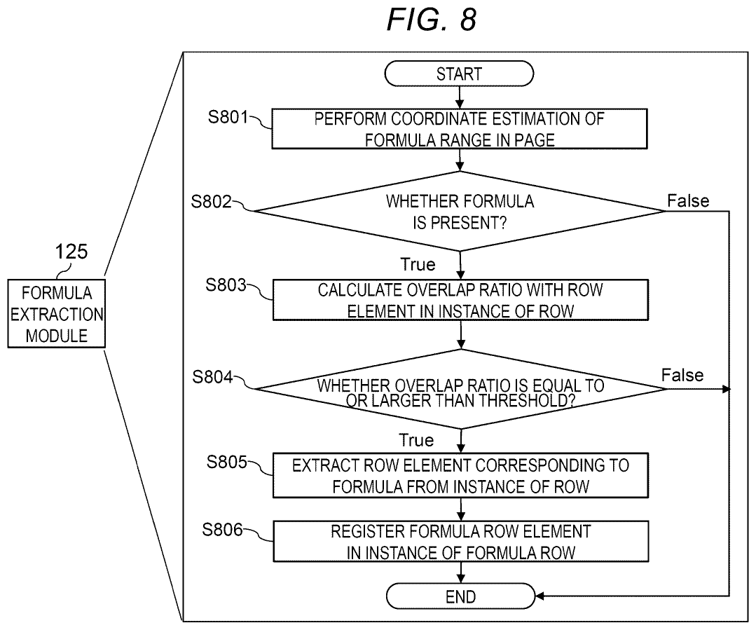

The formula extraction module 125 extracts a row element corresponding to a formula (hereinafter, formula row element) from the row element in the instance of the row. The formula extraction module 125 is executed in page units according to, for example, an algorithm shown in a flowchart in FIG. 8.

FIG. 8 is a flowchart showing an example of a formula extraction processing procedure performed by the formula extraction module 125.

### Step S801

The formula extraction module 125 attempts to perform coordinate estimation of a formula range in a processing target page of the structuring target document data 101. The coordinate estimation of the formula range can be implemented by using an object detection model such as X101 trained from a DocBank data set, similarly to the processing modules 12# in FIG. 5 to FIG. 7.

### Step S802

The formula extraction module 125 determines whether a chart region estimated to be a formula (hereinafter, formula estimation region) is present. If step S802 is false (step S802: False), formula extraction processing performed by the formula extraction module 125 in the page ends, and when there is a next page, the formula extraction module 125 executes the formula extraction processing using the next page as a processing target page. If step S802 is true (step S802: True), the processing proceeds to step S803.

### Step S803

The formula extraction module 125 calculates an overlap ratio between the formula estimation region and the row element in the instance of the row. A formula estimation region 265 is estimated in FIG. 2 by step S802.
Example 803-1: For example, the row element for which the overlap ratio is to be calculated is the token string “y=Ax+B . . . (1)” which is the character string 255. In this case, an overlap ratio between the formula estimation region 265 and the row element is calculated as 100%.

### Step S804

The formula extraction module 125 determines whether the overlap ratio calculated in step S803 is equal to or larger than a threshold. Although the threshold can be set by the user, since the overlap ratio is calculated in a range of 0% to 100%, a setting value assumed on the structuring device 100 side may be used as a default value of the threshold. If step S804 is false (step S802: False), the formula extraction processing performed by the formula extraction module 125 in the page ends, and when there is a next page, the formula extraction module 125 executes the formula extraction processing using the next page as a processing target page. If step S804 is true (step S804: True), the processing proceeds to step S805.

In the case of the above example 803-1, when the threshold is, for example, 60%, it is determined that the token string “y=Ax+B . . . (1)” which is the row element is a formula, and step S804 is true (step S504: True).

### Step S805

The formula extraction module 125 extracts, as a formula row element, the row element determined as the formula from the instance of the row, and deletes the extracted row element from the instance of the row. In the case of the above example 803-1, the formula extraction module 125 deletes the token string “y=Ax+B . . . (1)” of the character string 255, which is the row element, from the instance of the row.

### Step S806

The formula extraction module 125 associates the row element extracted in step S805 with a page number and a row number, and registers the row element as the formula row element in an instance of a formula corresponding row. Thereafter, the formula extraction processing performed by the formula extraction module 125 in the page ends, and when there is a next page, the formula extraction module 125 executes the formula extraction processing using the next page as a processing target page.

In the case of the above example 803-1, the formula extraction module 125 associates the token string “y=Ax+B . . . (1)” of the character string 255, which is the row element, with a page number and a row number, and registers the row element as the formula row element in the instance of the formula corresponding row.

### Auxiliary Information Extraction Module 126

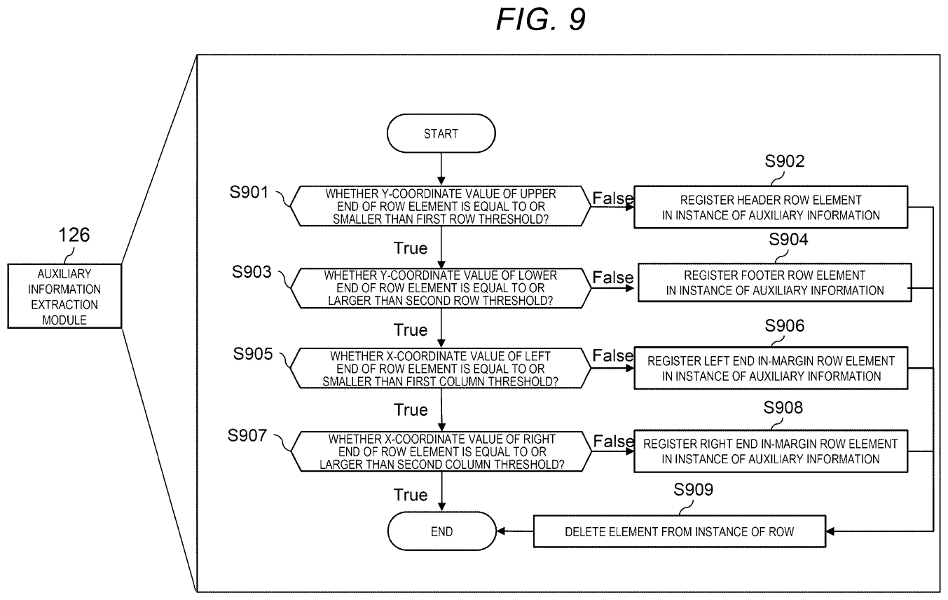

The auxiliary information extraction module 126 extracts auxiliary information called a header element or a footer element. The auxiliary information extraction module 126 is executed in row units according to, for example, an algorithm shown in a flowchart in FIG. 9.

FIG. 9 is a flowchart showing an example of an auxiliary information extraction processing procedure performed by the auxiliary information extraction module 126.

### Step S901

The auxiliary information extraction module 126 determines whether a Y-coordinate value of an upper end of the row element is equal to or smaller than a first row threshold. In the example of FIG. 2, the auxiliary information extraction module 126 determines whether the Y-coordinate value of the upper end of the row element is equal to or smaller than the Y-coordinate value of the first row line L1. If step S901 is true (step S901: True), the processing proceeds to step S903. If step S901 is false (step S901: False), the processing proceeds to step S902.

### Step S902

The auxiliary information extraction module 126 registers the row element as a header row element in an instance of the auxiliary information, and the processing proceeds to step S909.

### Step S903

The auxiliary information extraction module 126 determines whether a Y-coordinate value of a lower end of the row element is equal to or larger than a second row threshold. In the example of FIG. 2, the auxiliary information extraction module 126 determines whether the Y-coordinate value of the lower end of the row element is equal to or smaller than the Y-coordinate value of the second row line L2. If step S903 is true (step S903: True), the processing proceeds to step S905. If step S903 is false (step S903: False), the processing proceeds to step S904.

### Step S904

The auxiliary information extraction module 126 registers the row element as a footer row element in the instance of the auxiliary information, and the processing proceeds to step S909. In the example of FIG. 2, two stages of token strings “Annual Meeting 2023, pages 1234-1244”, and “Jul. 9-14, 2023.” indicating the character string 220 are registered as footer row elements in the instance of the auxiliary information.

### Step S905

The auxiliary information extraction module 126 determines whether an X-coordinate value of a left end of the row element is equal to or smaller than a first column threshold. In the example of FIG. 2, the auxiliary information extraction module 126 determines whether the X-coordinate value of the left end of the row element is equal to or smaller than the X-coordinate value of the first column line C1. If step S905 is true (step S905: True), the processing proceeds to step S907. If step S905 is false (step S905: False), the processing proceeds to step S906.

### Step S906

The auxiliary information extraction module 126 registers the row element as a left end in-margin row element in the instance of the auxiliary information.

### Step S907

The auxiliary information extraction module 126 determines whether an X-coordinate value of a right end of the row element is equal to or larger than a second column threshold. In the example of FIG. 2, the auxiliary information extraction module 126 determines whether the X-coordinate value of the right end of the row element is equal to or larger than the X-coordinate value of the second column line C2. If step S907 is true (step S907: True), auxiliary information extraction processing by the auxiliary information extraction module 126 in the row ends, and when there is a next row, the auxiliary information extraction module 126 executes the auxiliary information extraction processing using the next row as a processing target row. If step S907 is false (step S907: False), the processing proceeds to step S908.

### Step S908

The auxiliary information extraction module 126 registers the row element as a right end in-margin row element in the instance of the auxiliary information.

### Step S909

The auxiliary information extraction module 126 deletes the row element from the instance of the row. In the example of FIG. 2, the two stages of the token strings “Annual Meeting 2023, pages 1234-1244”, and “Jul. 9-14, 2023.” indicating the character string 220 are deleted from the instance of the row.

Thereafter, the auxiliary information extraction processing performed by the auxiliary information extraction module 126 in the page ends, and when there is a next page, the auxiliary information extraction module 126 executes the auxiliary information extraction processing using the next page as a processing target page.

Although the thresholds in steps S901, S903, S905, and S907 can be set by the user, since the coordinate system in Embodiment 1 is standardized, a setting value assumed on the structuring device 100 side may be used as a default value of the threshold.

### Paragraph Extraction Module 127

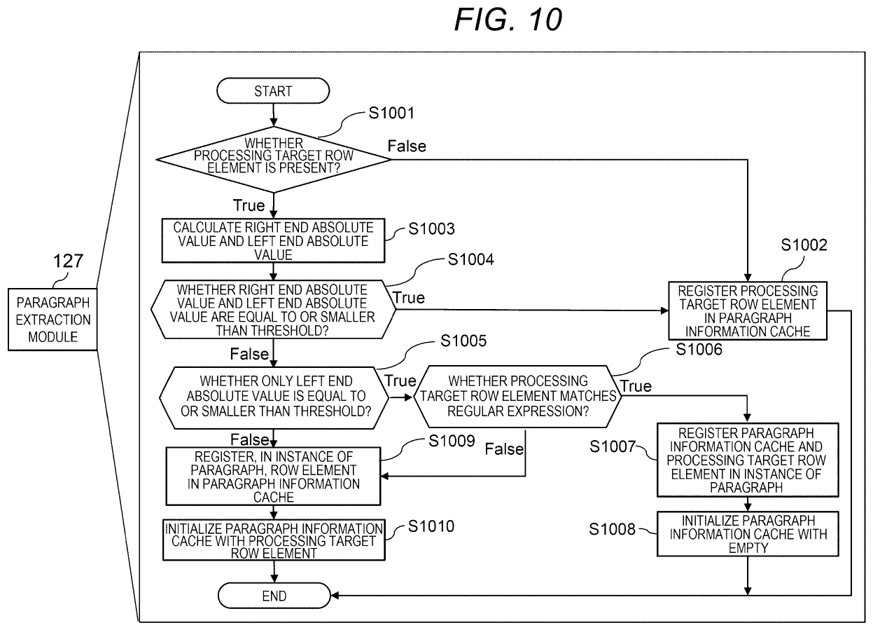

The paragraph extraction module 127 extracts a paragraph element from the instance of the row. The paragraph extraction module 127 is executed in row units according to, for example, an algorithm shown in a flowchart in FIG. 10.

FIG. 10 is a flowchart showing an example of a paragraph extraction processing procedure performed by the paragraph extraction module 127. In the example of FIG. 2, in this stage, a token string indicating the character strings 251, 252, and 257 among the character strings 220, 251, 252, and 254 to 257 remains in the instance of the row. The paragraph extraction module 127 uses a paragraph information cache. In an initial stage, paragraph information is empty. In the paragraph information cache, tokens in the same paragraph are held by the execution of the paragraph extraction module 127.

### Step S1001

The paragraph extraction module 127 determines whether a row element immediately preceding a processing target row element is present in the instance of the row. The processing target row element is a leading row element in the reading order in the instance of the row at the initial stage. In the case of the structuring target document data 101 shown in FIG. 2, “Test Paper” of the character string 251 is the leading row element. When the processing target row element is the leading row element, step S1001 is false (step S1001: False).

If step S1001 is true (step S1001: True), the processing proceeds to step S1003. If step S1001 is false (step S1001: False), the processing proceeds to step S1002.

### Step S1002

The paragraph extraction module 127 stores the processing target row element in the paragraph information cache. Paragraph extraction processing performed by the paragraph extraction module 127 in the row ends, and when there is a next row, the paragraph extraction module 127 executes the paragraph extraction processing using the next row as a processing target row.

### Step S1003

The paragraph extraction module 127 calculates an absolute value (hereinafter, right end absolute value) of a difference between the X-coordinate value of the right end of the processing target row element and an X-coordinate value of the right end of the immediately preceding row element, and calculates an absolute value (hereinafter, left end absolute value) of a difference between the X-coordinate value of the left end of the processing target row element and an X-coordinate value of the left end of the immediately preceding row element.

### Step S1004

The paragraph extraction module 127 determines whether both the right end absolute value and the left end absolute value calculated in step S1002 are equal to or smaller than a threshold. Although the threshold can be set by the user, since the coordinate system in Embodiment 1 is standardized, a setting value assumed on the structuring device 100 side may be used as a default value of the threshold. If step S1004 is true (step S1004: True), the immediately preceding row element and the processing target row element are regarded as belonging to the same paragraph, and therefore the processing proceeds to step S1003. If step S1004 is false (step S1004: False), the processing proceeds to step S1005.

### Step S1005

The paragraph extraction module 127 determines whether only the left end absolute value is equal to or smaller than a threshold. The threshold is the same value as in step S1004. If step S1005 is false (step S1005: False), the processing proceeds to step S1009. If step S1005 is true (step S1005: True), there is a possibility that the paragraph ends in the processing target row element, and therefore the processing proceeds to step S1006.

### Step S1006

The paragraph extraction module 127 determines whether the processing target row element matches a regular expression for detecting a sentence-end expression. The regular expression can use, for example, “.*?[.!?:;]″?¥s*[0-9]*$”.

The regular expression “.*?” is a part indicating that any character “.” can be repeated zero or more times “*”, and “?” means non-greedy and is used to match as few characters as possible. That is, the regular expression “.*?” matches characters up to a position where the next part (., !, ?, :, ;) first appears.

The regular expression “[.!?:;]” indicates that it matches any character among the characters contained within the square bracket [ ]. Specifically, the regular expression “[.!?:;]” matches any one of “., !, ?, :, ;”.

The regular expression “″?” indicates that a double quotation mark “″” appears zero or one time. “?” indicates that the previous element appears zero or one time.

The regular expression “¥s*” indicates that a blank character (space, tab, line feed, and the like) appears zero or more times “*”. “¥s” is an escape sequence indicating a blank character.

The regular expression “[0-9]*” indicates that the numerals from zero to nine appear zero or more times “*”. That is, the regular expression “[0-9]*” matches any numeral.

The regular expression “$” indicates that it matches an end of a character string. That is, the regular expression matches a part following an end of a target text character string.

If step S1006 is false (step S1006: False), it is regarded that the paragraph ends in the immediately preceding row element, and therefore the processing proceeds to step S1009. If step S1006 is true (step S1006: True), the paragraph ends in the processing target row element, and therefore the processing proceeds to step S1007.

### Step S1007

Since the row element and the processing target row element registered in the paragraph information cache form the same paragraph and the processing target row element is regarded as the last row in the paragraph element, the paragraph extraction module 127 registers the row element and the processing target row element registered in the paragraph information cache as an instance of the paragraph. Then, the processing proceeds to step S1008.

### Step S1008

The paragraph extraction module 127 newly initializes the paragraph information cache with empty. The paragraph extraction processing performed by the paragraph extraction module 127 in the row ends, and when there is a next row, the paragraph extraction module 127 executes the paragraph extraction processing using the next row as a processing target row.

### Step S1009

The paragraph extraction module 127 registers, in the instance of the paragraph, the row element in the paragraph information cache, and the processing proceeds to step S1010.

### Step S1010

The paragraph extraction module 127 initializes the paragraph information cache with the processing target row element. Thereafter, the paragraph extraction processing performed by the paragraph extraction module 127 in the row ends, and when there is a next row, the paragraph extraction module 127 executes the paragraph extraction processing using the next row as a processing target row.

### Chapter Structure Detection Module 128

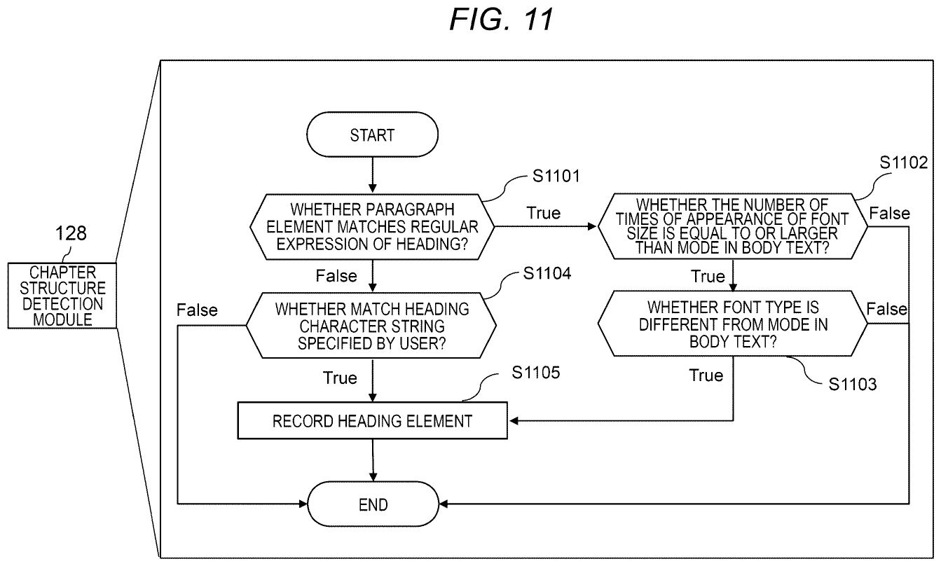

The chapter structure detection module 128 detects a chapter name for each paragraph. The chapter structure detection module 128 is executed in paragraph units according to, for example, an algorithm shown in a flowchart in FIG. 11.

FIG. 11 is a flowchart showing an example of a chapter structure detection processing procedure performed by the chapter structure detection module 128.

### Step S1101

The chapter structure detection module 128 determines whether a processing target paragraph element in the instance of the paragraph matches a regular expression for detecting a heading expression. The regular expression can use, for example, “\hat{ }([IVXLCDM¥.]+|([A-Z0-9][0-9¥.]*))¥s([\hat{ }¥.]*)$”.

The caret “\hat{ }” which is the regular expression indicates a leading of a character string. That is, the regular expression starts matching from the leading of the character string.

The regular expression “\hat{ }([IVXLCDM¥.]+|([A-Z0-9][0-9¥.]*))” indicates that two regular expression patterns are separated by a “|” (pipe) and that either pattern is matched. Specifically, the regular expression is established by the following two sub-patterns.

The sub-pattern “([IVXLCDM¥.]+” matches a repetition of one or more characters of Roman numerals or periods “.”.

The sub-pattern “([A-Z0-9][0-9¥.]*))” starts from an uppercase character or a numeral, and matches a repetition of zero or more numerals or periods “.”. The sub-pattern “([A-Z0-9][0-9¥.]*))” matches a character string of consecutive alphabets or a character string including numerals and periods.

The regular expression “¥s” matches a blank character (space, tab, line feed, and the like).

The regular expression “([\hat{ }¥.]*)” matches zero or more repetitions of a character other than the period “.”.

The regular expression “$” matches an end of a text character string.

If step S1101 is false (step S1101: False), the processing proceeds to step S1104. If step S1101 is true (step S1101: True), there is a high possibility that the processing target paragraph element is a heading, the processing proceeds to step S1102.

### Step S1102

The chapter structure detection module 128 determines whether a font size of a token in the processing target paragraph element is equal to or larger than a font size of a mode of tokens in the body text 205. For example, the chapter structure detection module 128 specifies the font size for each token in the body text 205 from the instance of the page, and calculates the mode by assuming the mode as the font size of the body text 205.

If step S1102 is true (step S1102: True), the processing proceeds to step S1103. If step S1102 is false (step S1102: False), since the paragraph element is not regarded as a heading, chapter structure detection processing performed by the chapter structure detection module 128 in the paragraph ends, and when there is a next paragraph, the chapter structure detection module 128 executes the chapter structure detection processing using the next paragraph as a processing target paragraph.

### Step S1103

The chapter structure detection module 128 determines whether a font type of the processing target paragraph element is different from a font type of the mode of the tokens in the body text 205. For example, the chapter structure detection module 128 specifies the font type which is the meta information of the tokens in the body text 205 from the instance of the page, and calculates the mode. If step S1103 is true (step S1103: True), the processing proceeds to step S1105. If step S1103 is false (step S1103: False), since the processing target paragraph element is not regarded as a heading, the chapter structure detection processing performed by the chapter structure detection module 128 in the paragraph ends, and when there is a next paragraph, the chapter structure detection module 128 executes the chapter structure detection processing using the next paragraph as a processing target paragraph.

### Step S1104

The chapter structure detection module 128 determines whether the processing target paragraph element matches a heading character string specified by the user. Step S1104 is processing for corresponding to a heading expression that cannot be covered by the regular expression in step S1101. If step S1104 is true (step S1104: True), the processing proceeds to step S1105. If step S1104 is false (step S1104: False), since the processing target paragraph element is not regarded as a heading, the chapter structure detection processing performed by the chapter structure detection module 128 in the paragraph ends, and when there is a next paragraph, the chapter structure detection module 128 executes the chapter structure detection processing using the next paragraph as a processing target paragraph.

### Step S1105

The chapter structure detection module 128 records the processing target paragraph element as a heading element and both the page number and the row number. Thereafter, the chapter structure detection processing performed by the chapter structure detection module 128 in the paragraph ends, and when there is a next paragraph, the chapter structure detection module 128 executes the chapter structure detection processing using the next paragraph as a processing target paragraph.

### Column Coupling Module 129

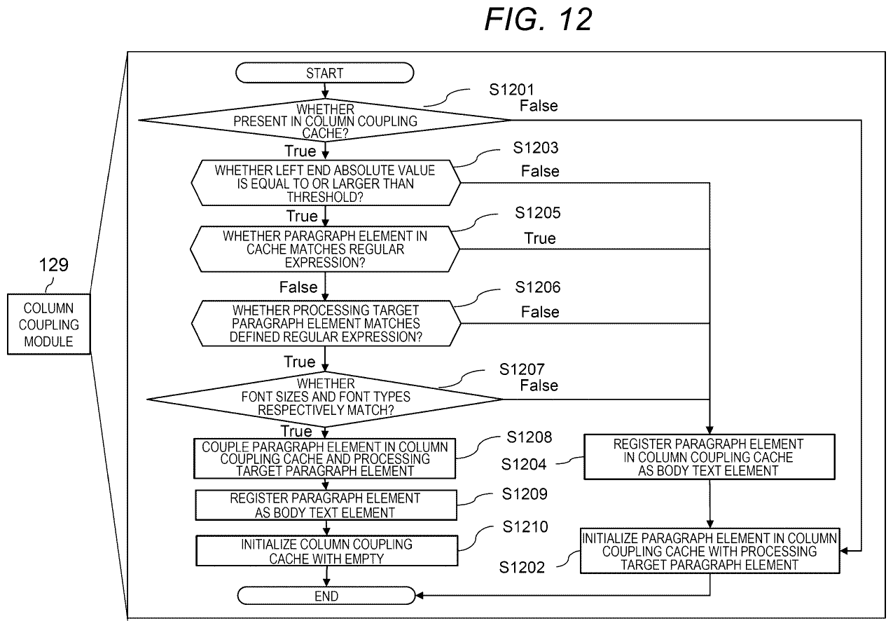

The column coupling module 129 couples a plurality of columns when paragraph elements that are divided into the plurality of columns are the same paragraph element. The column coupling module 129 is executed in paragraph units according to, for example, an algorithm shown in a flowchart in FIG. 12.

FIG. 12 is a flowchart showing an example of a column coupling processing procedure performed by the column coupling module 129. The column coupling module 129 uses a column coupling cache. In an initial stage, the column coupling cache is empty, and the column coupling cache holds tokens in the same paragraph by the execution of the column coupling module 129. In the initial stage, a leading paragraph element in a reading order in the instance of the paragraph is set as the processing target paragraph element.

### Step S1201

The column coupling module 129 determines whether a paragraph element is present in the column coupling cache. In the initial stage, since the column coupling cache is empty, step S1201 is false (step S1201: False). If step S1201 is true (step S1201: True), the processing proceeds to step S1203. If step S1201 is false (step S1201: False), the processing proceeds to step S1202.

### Step S1202

The column coupling module 129 initializes the column coupling cache with the processing target paragraph element. Then, column coupling processing performed by the column coupling module 129 in the processing target paragraph element ends, and when there is a next paragraph, the column coupling module 129 executes the column coupling processing using the paragraph element of the next paragraph as a processing target paragraph element.

### Step S1203

The column coupling module 129 determines whether an absolute value (left end absolute value) of a difference between an X-coordinate value of a left end of the paragraph element stored in the column coupling cache and an X-coordinate value of a left end of the processing target paragraph element is equal to or larger than a threshold. Although the threshold can be set by the user, since the coordinate system in Embodiment 1 is standardized, a setting value assumed on the structuring device 100 side may be used as a default value of the threshold. If step S1203 is true (step S1203: True), there is a possibility that one paragraph straddles two consecutive columns, and therefore the processing proceeds to step S1205.

The two consecutive columns are two consecutive columns in the same page, or a column at the end of the page and a leading column of the next page. For example, when two columns (a left column and a right column) are present in one page, when the paragraph element stored in the column coupling cache is located at the end of the left column and the processing target paragraph element is located at the leading of the right column, the paragraph element and the processing target paragraph element are coupled depending on the determination result of steps S1205 to S1207, and become one paragraph element straddling the left column and the right column. If step S1203 is false (step S1203: False), the processing proceeds to step S1204.

### Step S1204

The column coupling module 129 registers the paragraph element stored in the column coupling cache as a body text element in the instance of the page, and the processing proceeds to step S1202.

### Step S1205

The column coupling module 129 determines whether the paragraph element stored in the column coupling cache matches a regular expression for detecting a sentence end. The regular expression can use, for example, “.*?[ [symbol] . . ! ! ? ?]″?[0-9]*$”.

The regular expression “[ [symbol] . . ! ! ? ?]” indicates that it matches any character among the characters contained within the square bracket [ ]. Specifically, the regular expression “[ [symbol] . . ! ! ? ?]” matches one of the Japanese punctuation marks “ [symbol] ” and “ [symbol] ”, the English punctuation marks “.”, “!”, and “?”, and the corresponding full-width/half-width periods “.”, “!”, and “?”.

The regular expression “[0-9]*” indicates that the numerals from zero to nine appear zero or more times “*”. That is, the regular expression “[0-9]*” matches any numeral.

If step S1205 is true (step S1205: True), the processing proceeds to step S1204, and the paragraph element stored in the column coupling cache is registered as the body text element in the instance of the page. If step S1205 is false (step S1205: False), the processing proceeds to step S1206.

“.*?[ [symbol] . . [symbol] , , ! ! ? ? : :]$”

### Step S1206

The column coupling module 129 determines whether the processing target paragraph element matches a regular expression for detecting a sentence end. The regular expression can use, for example, “.*?[ [symbol] . . [symbol] , , ! ! ? ? : :]$”.

The regular expression “[ [symbol] . . [symbol] , , ! ! ? ? : :]” indicates that it matches any character among the characters contained within the square bracket [ ]. Specifically, the regular expression “[ [symbol] . . [symbol] , , ! ! ? ? : :]” matches one of the Japanese punctuation marks “ [symbol] ” and “ [symbol] ”, the English punctuation marks “.”, “!”, “?”, and “:”, and the full-width/half-width variations thereof “.”, “!”, “?”, and “:”.

If step S1206 is false (step S1206: False), the processing proceeds to step S1204. If step S1206 is true (step S1206: True), the processing proceeds to step S1207.

### Step S1207

The column coupling module 129 determines whether a font size and a font type of the paragraph element stored in the column coupling cache match a font size and a font type of the processing target paragraph element. If step S1207 is false (step S1207: False), the processing proceeds to step S1204. If step S1207 is true (step S1207: True), the processing proceeds to step S1208.

### Step S1208

The column coupling module 129 couples the paragraph element that does not match the regular expression stored in the column coupling cache and the processing target paragraph element that matches the regular expression, and the processing proceeds to step S1209. Accordingly, two consecutive columns are coupled.

### Step S1209

The column coupling module 129 registers the paragraph element coupled in step S1208 as a body text element in the instance of the page, and the processing proceeds to step S1210.

### Step S1210

The column coupling module 129 initializes the column coupling cache with empty. Thereafter, the column coupling processing performed by the column coupling module 129 in the paragraph ends, and when there is a next paragraph, the column coupling module 129 executes the column coupling processing using the next paragraph as a processing target paragraph.

### Page Coupling Module 12A

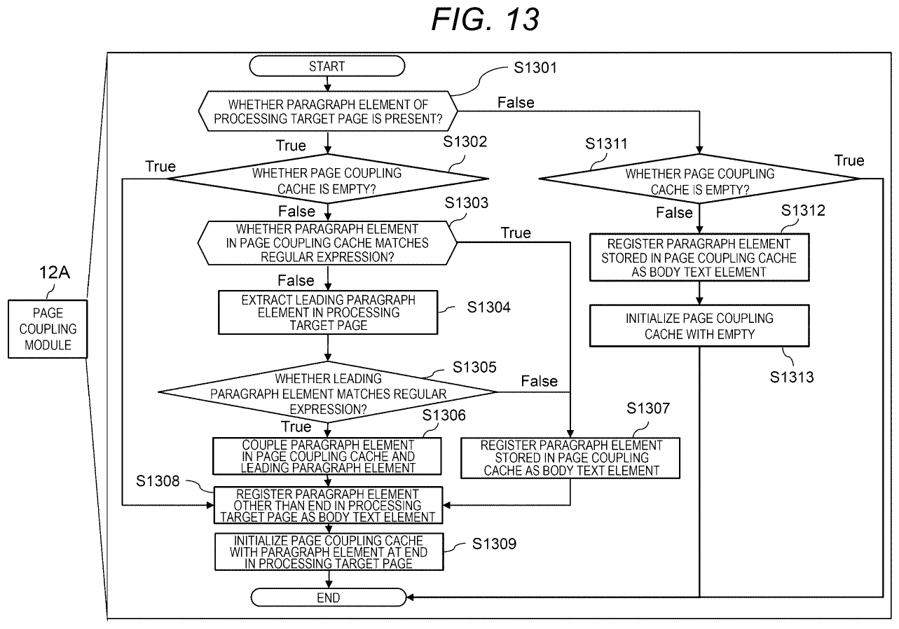

The page coupling module 12A couples a plurality of pages when paragraph elements that are divided into the plurality of pages are the same paragraph element. The page coupling module 12A is executed in page units according to, for example, an algorithm shown in a flowchart in FIG. 13.

FIG. 13 is a flowchart showing an example of a page coupling processing procedure performed by the page coupling module 12A. The page coupling module 12A uses a page coupling cache. In an initial stage, the page coupling cache is empty, and the page coupling cache holds tokens in the same page by the execution of the page coupling module 12A. In the initial stage, a leading page is set as the processing target page.

### Step S1301

The page coupling module 12A determines whether a paragraph element of a processing target page is present in the instance of the paragraph. If step S1301 is false (step S1301: False), the processing proceeds to step S1311. If step S1301 is true (step S1301: True), the processing proceeds to step S1302.

### Step S1302

The page coupling module 12A determines whether the page coupling cache is empty. In an initial stage, since the page coupling cache is empty, step S1302 is true (step S1302: True). If step S1302 is true (step S1302: True), the processing proceeds to step S1308. If step S1302 is false (step S1302: False), since a paragraph element at the end of the previous page of the processing target page is stored, the processing proceeds to step S1303.

### Step S1303

The page coupling module 12A determines whether the paragraph element in the page coupling cache matches a regular expression for detecting a sentence end. The regular expression can use, for example, “.*?[ [symbol] . . ! ! ? ?]″?[0-9]*$”.

The regular expression “[ [symbol] . . ! ! ??]” indicates that it matches any character among the characters contained within the square bracket [ ]. Specifically, the regular expression “[ [symbol] . . ! ! ??]” matches one of the Japanese punctuation marks “ [symbol] ” and “ [symbol] ”, the English punctuation marks “.”, “!”, and “?”, and the corresponding full-width/half-width periods “.”, “!”, and “?”. “[0-9]*” indicates that the numerals from zero to nine appear zero or more times “*”. That is, “[0-9]*” matches any numeral.

If step S1303 is true (step S1303: True), the processing proceeds to step S1307. If step S1303 is false (step S1303: False), the processing proceeds to step S1304.

### Step S1304

The page coupling module 12A extracts a leading paragraph element in the processing target page, and the processing proceeds to step S1305.

### Step S1305

The page coupling module 12A determines whether the extracted leading paragraph element matches the regular expression for detecting the sentence end. If step S1305 is false (step S1305: False), the processing proceeds to step S1307. If step S1305 is true (step S1305: True), the processing proceeds to step S1306.

### Step S1306

The page coupling module 12A couples the paragraph element that does not match the regular expression stored in the page coupling cache and the leading paragraph element that matches the regular expression extracted in step S1304, and the processing proceeds to step S1308. Accordingly, the previous page of the processing target page is coupled to the processing target page based on the coupling between the paragraph element at the end of the previous page of the processing target page and the leading paragraph element of the processing target page.

### Step S1307

The page coupling module 12A registers the paragraph element stored in the page coupling cache as the body text element in the instance of the page, and the processing proceeds to step S1308.

### Step S1308

The page coupling module 12A registers the paragraph elements other than the end in the processing target page as the body text element in the instance of the page, and the processing proceeds to step S1309.

### Step S1309

The page coupling module 12A initializes the page coupling cache with the paragraph element at the end of the processing target page. Thereafter, page coupling processing performed by the page coupling module 12A in the processing target page ends, and when there is a next page, the page coupling module 12A executes the page coupling processing using the next page as a processing target page.

### Step S1311

The page coupling module 12A determines whether the page coupling cache is empty. If step S1311 is true (step S1311: True), the page coupling processing performed by the page coupling module 12A in the page coupling cache ends, and when there is a next page, the page coupling module 12A executes the page coupling processing using the next page as a processing target page. If step S1311 is false (step S1311: False), the processing proceeds to step S1312.

### Step S1312

The page coupling module 12A registers the paragraph element stored in the page coupling cache as the body text element in the instance of the page, and the processing proceeds to step S1313.

### Step S1313

The page coupling module 12A initializes the page coupling cache with empty. Thereafter, the page coupling processing performed by the page coupling module 12A in the processing target page ends, and when there is a next page, the page coupling module 12A executes the page coupling processing using the next page as a processing target page.

### Output Module 12B

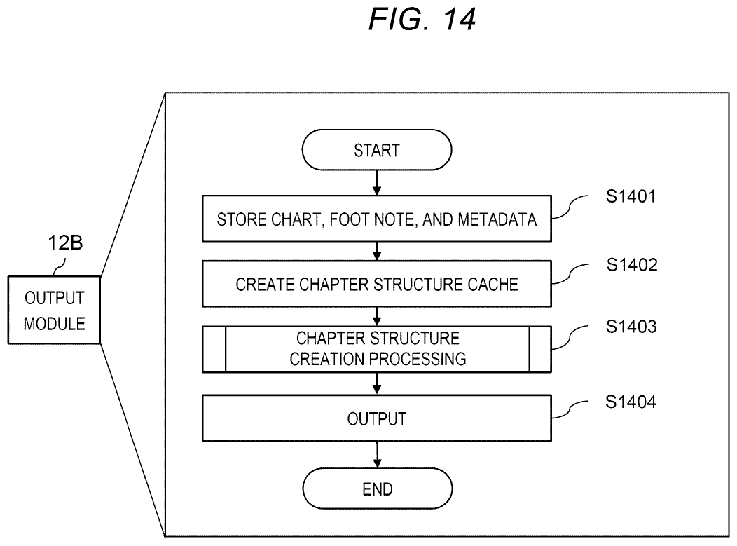

The output module 12B outputs the structured data 131. The output module 12B is executed in paragraph element units according to, for example, an algorithm shown in a flowchart in FIG. 14.

FIG. 14 is a flowchart showing an example of an output processing procedure performed by the output module 12B.

### Step S1401

The output module 12B stores, as output data, an object such as a chart, a foot note, and metadata extracted by object extraction (step S305) performed by the data loading module 120, and the processing proceeds to step S1402.

### Step S1402

The output module 12B creates a chapter structure cache, and the processing proceeds to step S1403. The chapter structure cache is a dictionary-type cache and includes a heading element region and a content element region therein. The output module 12B stores a heading element of a certain chapter structure in the heading element region, and stores a paragraph element belonging to the chapter structure in the content element region.

### Step S1403

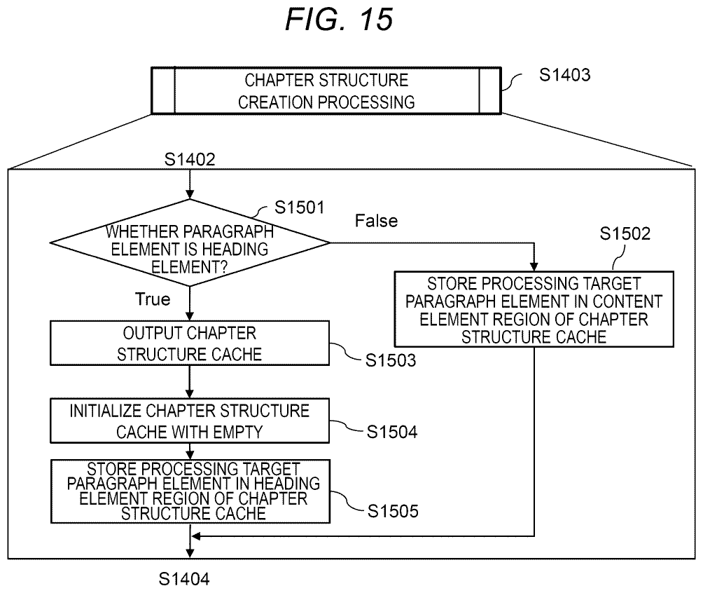

The output module 12B executes chapter structure creation processing, and the processing proceeds to step S1404. The chapter structure creation processing will be described later with reference to FIG. 15.

### Step S1404

The output module 12B associates the output data stored in step S1401 with the paragraph element in the content element region, and outputs, as the structured data 131, the output data together with the heading element in the heading element region.

### Chapter Structure Creation Processing (Step S1403)

FIG. 15 is a flowchart showing a detailed processing procedure example of the chapter structure creation processing (step S1403) performed by the output module 12B. A paragraph element that is not extracted in the reading order in the instance of the paragraph is set as a processing target paragraph element.

### Step S1501

The output module 12B determines whether the processing target paragraph element is a heading element based on a chapter structure detection result (step S1105) obtained by the chapter structure detection module 128. If step S1501 is true (step S1501: True), the processing proceeds to step S1503. If step S1501 is false (step S1501: False), the processing proceeds to step S1502.

### Step S1502

The output module 12B stores the processing target paragraph element in the content element region of the chapter structure cache, and the processing proceeds to step S1404.

### Step S1503

The output module 12B stores the chapter structure cache as the output data (the heading element in the heading element region and a content element in the content element region), and the processing proceeds to step S1504.

### Step S1504

The output module 12B initializes the chapter structure cache with empty, and the processing proceeds to step S1505.

### Step S1505

The output module 12B stores the processing target paragraph element in the heading element region of the chapter structure cache initialized with empty, and the processing proceeds to step S1404.

### Structured Data 131

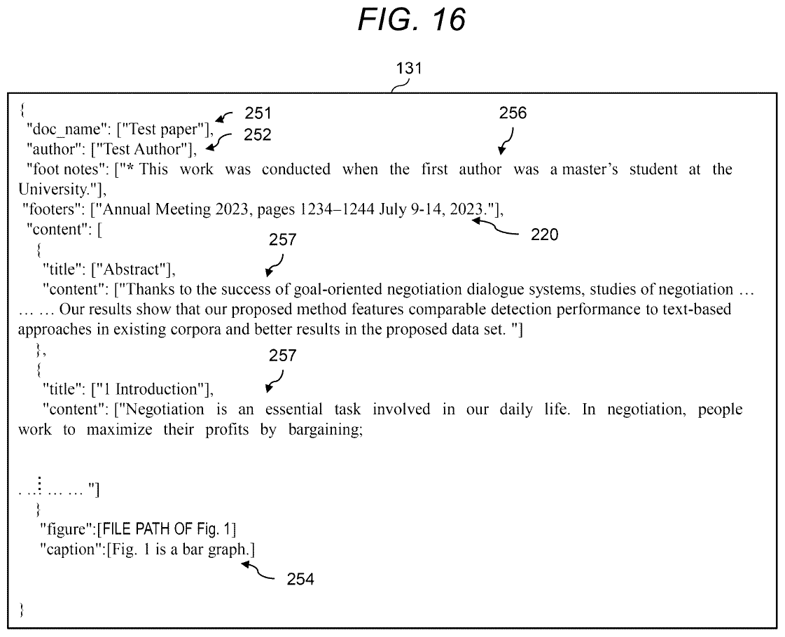

FIG. 16 is a diagram showing an example of the structured data 131. The structured data 131 is data obtained by structuring the structuring target document data 101. The structured data 131 is data obtained by structuring the structuring target document data 101 for each section. The section includes a section name represented by “xxx” and section information represented by [yyy]. For example, “Test Paper” which is the heading in the structuring target document data 101 is stored as section information of a section name “doc_name” in the structured data 131.

The section information also stores a further detailed section name and section information. For example, the output data (the heading element in the heading element region and the content element in the content element region) from the chapter structure cache is stored as section information of a section name “content”. Further, “Abstract”, which is a heading element in the heading element region, is stored as section information of a section name “title”, and “Thanks to the success of goal-oriented negotiation dialogue systems, studies of Negotiation . . . in the proposed data set.”, which is a content element in the content element region, is stored as section information of the section name “content”.

“Test Author”, which is the author name in the structuring target document data 101, is stored in “author” in the structured data 131. “* This work was conducted when the author was a master's student at the University.”, which is the foot note in the structuring target document data 101, is stored in “foot notes” in the structured data 131 as one element of a character string of a list structure.

“Annual Meeting 2023, pages 1234-1244” and “Jul. 9-14, 2023.”, which are the character strings 220 in the structuring target document data 101, are stored in “footers” as footer information in the structured data 131.

An element “Thanks to the success of goal-oriented negotiation dialogue systems, . . . ” associated with “Abstract” in the structuring target document data 101 is stored in dictionary-type data as one element of the list structure of “content” in the structured data 131.

Similarly, an element “Negotiation is an essential task involved in our daily life . . . . ” associated with “1 Introduction” in the structuring target document data 101 is stored in dictionary-type data as one element of the list structure of “content” in the structured data 131.

The dictionary-type data includes “title” and “content” as keys, and stores the section heading and the associated text. Any data format may be used as the data format of the structured data 131 as long as it is a data format capable of implementing the above contents. In the embodiment, it is assumed that JavaScript Object Notation (JSON) format is used for convenience.

The bar graph 253, which is a chart in the structuring target document data 101, is stored in “figure” as a file path to the bar graph 253 stored in the instance of the object in the structured data 131. The structuring device 100 can access the bar graph 253 through the file path.

“FIG. 1 is a bar graph.”, which is the character string 254 indicating a caption in the structuring target document data 101, is stored in “caption” in the structured data 131. Although not shown, the same applies to formulas and auxiliary information.

The structuring device 100 has a plurality of granularities of structuring, and examples of the granularity include token (word) units, row units, paragraph units, and section units. The granularities can be extracted by applying the data loading module 120, the row extraction module 121, the paragraph extraction module 127, and the chapter structure detection module 128. The granularities of the structuring can be adjusted by providing a type of the output module 12B for each granularity.

### Dependency Relationship Between Processing Modules 12#

A dependency relationship is set for each processing module 12#. That is, the processing module 12# cannot be applied in an order that does not satisfy the dependency relationship. The dependency relationship is defined as dependency relationship data.

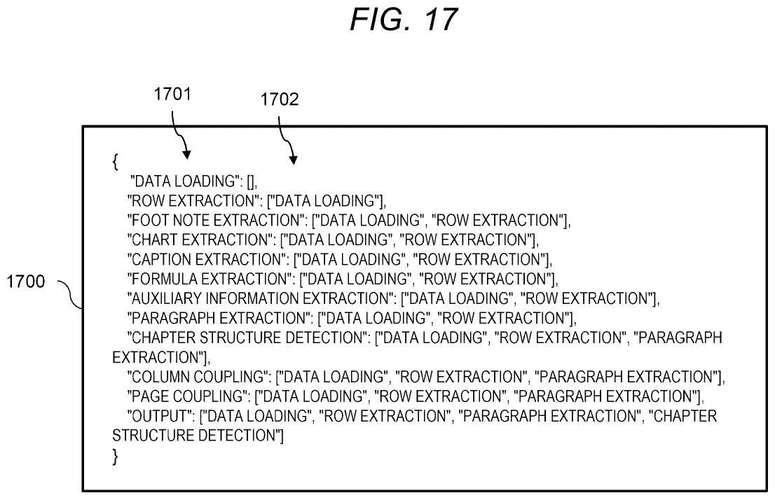

FIG. 17 is a diagram showing an example of the dependency relationship data in which the dependency relationship is defined. Dependency relationship data 1700 includes a key 1701 and a value 1702. The processing module 12# as a dependency destination is defined in the key 1701. The value 1702 stores a name of a dependency source processing module 12# to be executed earlier than the processing module 12# defined by the key 1701 in a list form.

The dependency relationship between the processing modules 12# is defined by the template data 111 with reference to the dependency relationship data 1700. The template data 111 includes one or more any processing modules 12# included in the processing module pool 102, and is a module column indicating an application order of the processing modules 12#.

### Template Data 111

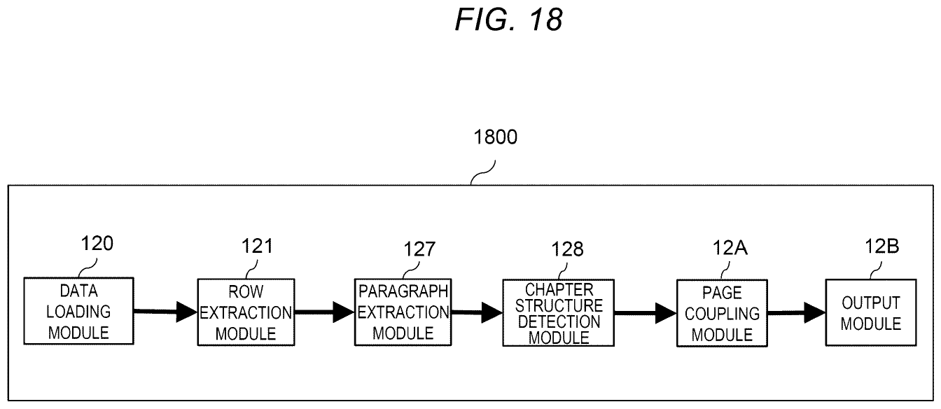

FIG. 18 is a diagram showing an example of the template data 111. Template data 1800 is an example of the template data 111, and is defined in an order of the data loading module 120, the row extraction module 121, the paragraph extraction module 127, the chapter structure detection module 128, the page coupling module 12A, and the output module 12B.

In the template data 1800, the data loading module 120 is applied to the structuring target document data 101. Thereafter, the row extraction module 121, the paragraph extraction module 127, the chapter structure detection module 128, the page coupling module 12A, and the output module 12B are applied in this order.

The processing module 12# may be embedded in the template data 1800, and the template data 1800 may be defined in any format as long as the data format can store order data. In Embodiment 1, for convenience, a list format is used. For example, a pointer to the processing module 12# is embedded in the template data 1800 in the list form. In this case, the structuring processing unit 130 described later acquires the processing module 12# from the processing module pool 102 by specifying the pointer.

### Setting Data

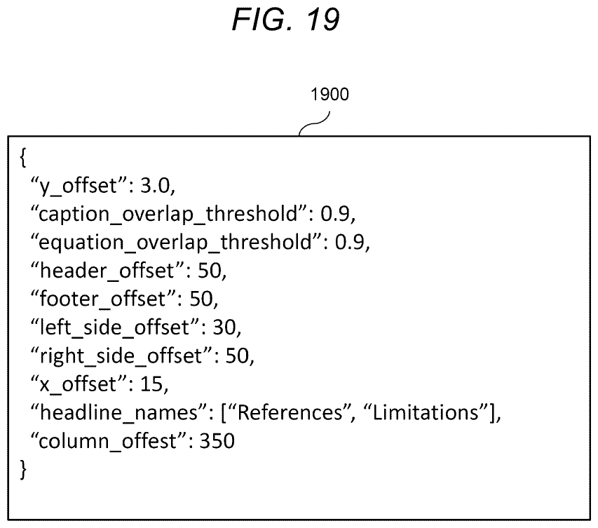

FIG. 19 is a diagram showing an example of setting data. Setting data 1900 defines a threshold, an overlap ratio, and a character string based on a user operation. In the setting data 1900, the threshold related to the row extraction in step S404 is specified in “y_offset”.

In “caption_overlap_threshold”, the threshold of the overlap ratio related to the foot note extraction in step S504 is specified. In “equation_overlap_threshold”, the threshold of the overlap ratio related to the formula extraction in step S804 is specified. In “header_offset”, the threshold related to the header extraction in step S901 is specified. In “footer_offset”, the threshold related to the foot note corresponding row element extraction in step S903 is specified.

In “left_side_offset”, the threshold of the left end of the page in step S905 is specified. In “right_side_offset”, the threshold of the right end of the page in step S907 is specified. In “x_offset”, the threshold of the paragraph extraction in step S1004 is specified. In “headline_names”, a list of the heading character strings specified by the user in step S1104 is specified. In “column_offset”, the threshold related to the column coupling in step S1203 is specified.

### Classification Unit 110 and Template Classifier 104

Referring back to FIG. 1, the classification unit 110 executes, by using the template classifier 104, acquisition processing of acquiring the structuring target document data 101 as input data and extraction processing of extracting, from the template data pool 103, the most appropriate template data 111 for structuring the structuring target document data 101.

Although a rule-based method and a method according to machine learning can be used in the template classifier 104, the rule-based method will be described in Embodiment 1. An example using the method according to machine learning in the template classifier 104 will be described in Embodiment 2.

The rule-based template classifier 104 defines template data for each feature of the layout of the structuring target document data 101. The rule-based template classifier 104 defines the processing module 12# for each feature of the layout of the structuring target document data 101. The features of the layout are, for example, the presence or absence of a foot note, a header, a chart, and a formula, and the column number (for example, a double column) in one page.

The feature of the layout of the structuring target document data 101 is specified by the classification unit 110 according to an input from the user.

Specifically, for example, when the feature of the layout of the input structuring target document data 101 is input by the user operation, the classification unit 110 refers to the rule-based template classifier 104, specifies, from the template classifier 104, the template data 111 corresponding to the feature of the specified layout input by the user operation, and extracts the template data 111 from the template data pool 103.

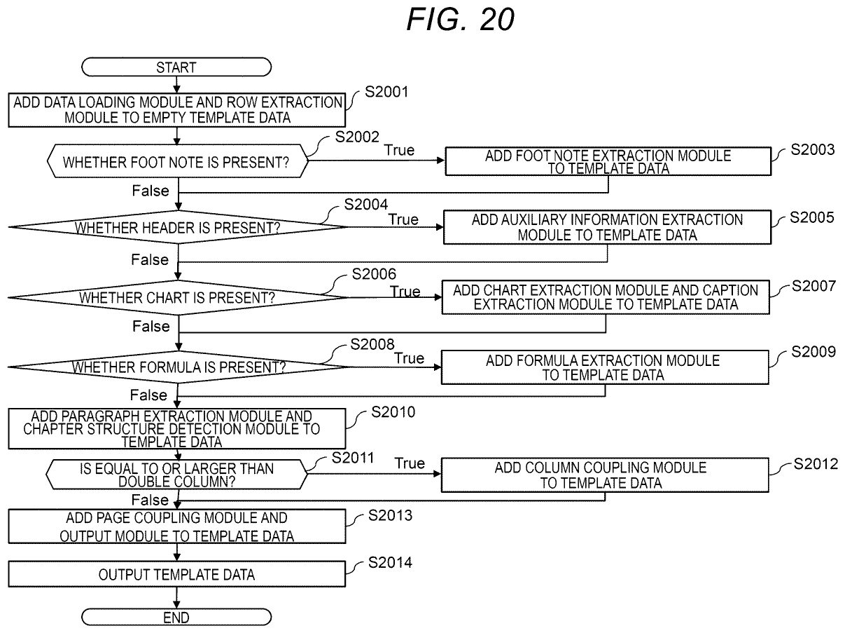

FIG. 20 is a flowchart showing an example of an extraction processing procedure of the template data 111. In FIG. 20, as an example, the data loading module 120, the row extraction module 121, the paragraph extraction module 127, the chapter structure detection module 128, the page coupling module 12A, and the output module 12B are essential processing modules 12# necessary for the template data 111, and the other processing modules 12# are selectable processing modules 12# that can be appropriately selected by the user. The processing module 12# to be set to the essential processing module 12# and the selectable processing module 12# may be changed as appropriate as long as the dependency relationship of the dependency relationship data 1700 is maintained.

For example, the data loading module 120, the row extraction module 121, the paragraph extraction module 127, the chapter structure detection module 128, and the output module 12B may be the essential processing modules 12#, and the other processing modules 12# may be the selectable processing modules 12#.

### Step S2001

The classification unit 110 adds the data loading module 120 and the row extraction module 121 to empty template data according to the dependency relationship defined by the dependency relationship data 1700.

### Step S2002

The classification unit 110 determines whether a foot note is present as a feature of the layout in the structuring target document data 101. Specifically, for example, when a selection input of the foot note is received by the user operation, step S2002 is true (step S2002: True). When the selection input of the foot note is not received by the user operation, step S2002 is false (step S2002: False).

If step S2002 is false (step S2002: False), the processing proceeds to step S2004. If step S2002 is true (step S2002: True), the processing proceeds to step S2003.

### Step S2003

The classification unit 110 adds the foot note extraction module 122 to the template data, to which the data loading module 120 and the row extraction module 121 are added, according to the dependency relationship defined by the dependency relationship data 1700, and the processing proceeds to step S2004.

### Step S2004

The classification unit 110 determines whether a header is present as a feature of the layout in the structuring target document data 101. Specifically, for example, when a selection input of the header is received by the user operation, step S2004 is true (step S2004: True). When the selection input of the header is not received by the user operation, step S2004 is false (step S2004: False).

If step S2004 is false (step S2004: False), the processing proceeds to step S2006. If step S2004 is true (step S2004: True), the processing proceeds to step S2005.

### Step S2005

The classification unit 110 adds the auxiliary information extraction module 126 to the template data, to which at least the data loading module 120 and the row extraction module 121 are added, according to the dependency relationship defined by the dependency relationship data 1700, and the processing proceeds to step S2006.

### Step S2006

The classification unit 110 determines whether a chart is present as a feature of the layout in the structuring target document data 101. Specifically, for example, when a selection input of the chart is received by the user operation, step S2006 is true (step S2006: True). When the selection input of the chart is not received by the user operation, step S2006 is false (step S2006: False).

If step S2006 is false (step S2006: False), the processing proceeds to step S2008. If step S2006 is true (step S2006: True), the processing proceeds to step S2007.

### Step S2007

The classification unit 110 adds the chart extraction module 123 and the caption extraction module 124 to the template data, to which at least the data loading module 120 and the row extraction module 121 are added, according to the dependency relationship defined by the dependency relationship data 1700, and the processing proceeds to step S2008.

### Step S2008

The classification unit 110 determines whether a formula is present as a feature of the layout in the structuring target document data 101. Specifically, for example, when a selection input of the formula is received by the user operation, step S2008 is true (step S2008: True). When the selection input of the formula is not received by the user operation, step S2008 is false (step S2008: False).

If step S2008 is false (step S2008: False), the processing proceeds to step S2010. If step S2008 is true (step S2008: True), the processing proceeds to step S2009.

### Step S2009

The classification unit 110 adds the formula extraction module 125 to the template data, to which at least the data loading module 120 and the row extraction module 121 are added, according to the dependency relationship defined by the dependency relationship data 1700, and the processing proceeds to step S2010.

### Step S2010

The classification unit 110 adds the paragraph extraction module 127 and the chapter structure detection module 128 to the template data, to which at least the data loading module 120 and the row extraction module 121 are added, according to the dependency relationship defined by the dependency relationship data 1700, and the processing proceeds to step S2011.

### Step S2011

The classification unit 110 determines whether the column number of the body text as a feature of the layout is equal to or larger than a double column in the structuring target document data 101. Specifically, for example, when a selection input that the column number of the body text is equal to or larger than the double column is received by the user operation, step S2011 is true (step S2008: True). When the selection input that the column number of the body text is equal to or larger than the double column is not received by the user operation, step S2011 is false (step S2011: False).

If step S2011 is false (step S2011: False), the processing proceeds to step S2013. If step S2011 is true (step S2011: True), the processing proceeds to step S2012.

### Step S2012

The classification unit 110 adds the column coupling module 129 to the template data, to which at least the data loading module 120, the row extraction module 121, the paragraph extraction module 127, and the chapter structure detection module 128 are added, according to the dependency relationship defined by the dependency relationship data 1700, and the processing proceeds to step S2013.

### Step S2013

The classification unit 110 adds the page coupling module 12A and the output module 12B to the template data, to which at least the data loading module 120, the row extraction module 121, the paragraph extraction module 127, and the chapter structure detection module 128 are added, according to the dependency relationship defined by the dependency relationship data 1700, and the processing proceeds to step S2014.

### Step S2014

The classification unit 110 generates and outputs the template data 111 by connecting the template data, to which at least the data loading module 120, the row extraction module 121, the paragraph extraction module 127, the chapter structure detection module 128, the page coupling module 12A, and the output module 12B are added, according to the dependency relationship between the processing modules 12#. Accordingly, the classification unit 110 ends the extraction processing of the template data 111.

### Structuring Processing Unit 130

Referring back to FIG. 1, the structuring processing unit 130 receives the structuring target document data 101, applies the template data 111 extracted by the classification unit 110 to the inputted structuring target document data 101, and executes the structuring processing according to a processing order in the template data 111. Then, the structuring processing unit 130 outputs the structured data 131 as an execution result of the structuring processing. The structuring processing unit 130 may store the structured data 131 and the structuring target document data 101 in association with each other.

### Setting Execution Screen

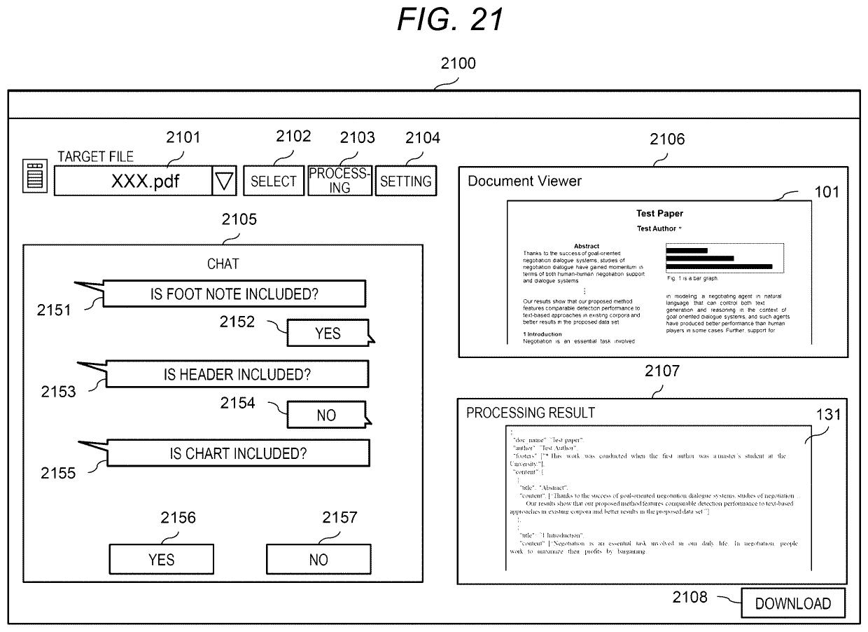

FIG. 21 is a diagram showing an example 1 of a setting execution screen of the structuring device 100 according to Embodiment 1. A setting execution screen 2100 is displayed on the structuring device 100 or another computer capable of communicating with the structuring device 100 via a network.

The setting execution screen 2100 includes a target file selection region 2101, a select button 2102, a processing button 2103, a setting button 2104, a chat column 2105, a document file display region 2106, a structured data display region 2107, and a download button 2108.

The target file selection region 2101 is a user interface that can select the structuring target document data 101 which is a target file, for example, by pulling down. In the target file selection region 2101, a file name of the selected structuring target document data 101 (“XXX.pdf” as an example in FIG. 21) is displayed.

The select button 2102 is a user interface for uploading, that is, reading the structuring target document data 101 selected in the target file selection region 2101, from a storage destination of the structuring target document data 101.

The processing button 2103 is a user interface for instructing the start of execution of processing by the structuring device 100 (the extraction processing by the classification unit 110 and the structuring processing by the structuring processing unit 210).

The setting button 2104 is a user interface for uploading, that is, reading the setting data 1900 shown in FIG. 19, from a storage destination of the setting data 1900. The read setting data 1900 is set in the corresponding processing module 12#.

The chat column 2105 is a display region in which conversation between the structuring device 100 and the user can be displayed in a chat format. When the extraction processing of the template data 111 shown in FIG. 20 is started by pressing the processing button 2103, an inquiry from the structuring device 100 is displayed as speech balloons 2151, 2153, and 2155 with tip ends leftward, and an answer result from the user is displayed as speech balloons 2152 and 2154 with tip ends rightward.

The chat column 2105 includes an accept button 2156 and a reject button 2157. The accept button 2156 is a user interface for allowing the user to accept the inquiry from the structuring device 100 by the user operation and for displaying “YES” in the chat column 2105.

The reject button 2157 is a user interface for allowing the user to reject the inquiry from the structuring device 100 by the user operation and for displaying “NO” in the chat column 2105.

In the chat column 2105, the speech balloon 2151 is displayed in the chat column 2105 by the execution of step S2002, the speech balloon 2153 is displayed in the chat column 2105 by the execution of step S2004, and the speech balloon 2155 is displayed in the chat column 2105 by the execution of step S2006.

After the speech balloon 2151 is displayed, when the accept button 2156 is pressed by the user operation, the speech balloon 2152 is displayed, and the structuring device 100 executes step S2003. After the speech balloon 2153 is displayed, when the reject button 2157 is pressed by the user operation, the speech balloon 2154 is displayed, and the structuring device 100 executes step S2005.

In the document file display region 2106, the uploaded structuring target document data 101 is displayed by pressing the select button 2102.

In the structured data display region 2107, the structured data 131 which is the execution result of the structuring processing unit 130 is displayed.

The download button 2108 is a user interface for downloading the structured data 131, that is, acquiring the structured data 131 from a storage destination of the structured data 131.

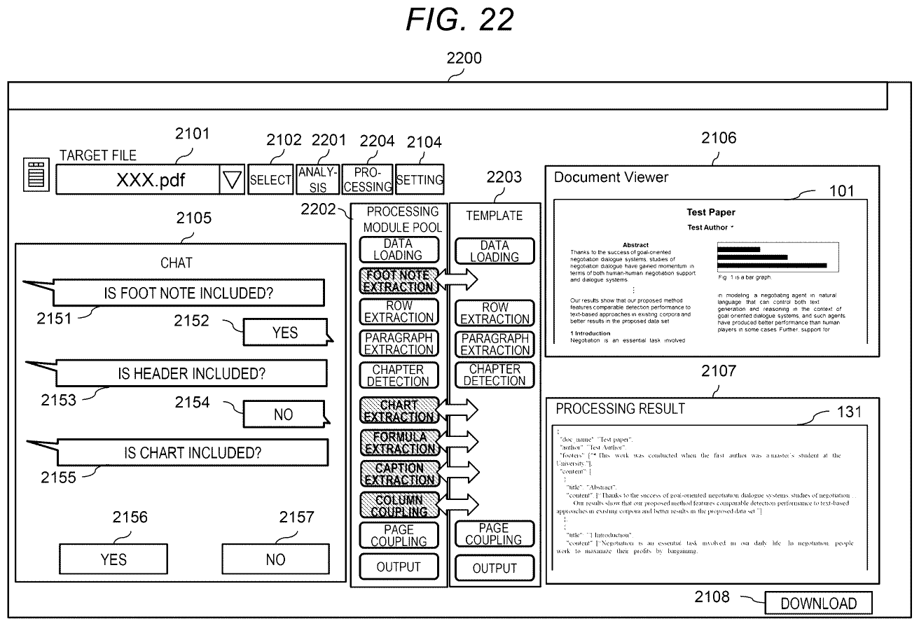

FIG. 22 is a diagram showing an example 2 of the setting execution screen of the structuring device 100 according to Embodiment 1. In a setting execution screen 2200, differences from the setting execution screen 2100 shown in FIG. 21 will be mainly described. The same components as those in the setting execution screen 2100 are denoted by the same signs, and the description thereof will be omitted.

The setting execution screen 2200 includes an analysis button 2201, a processing module pool display region 2202, a template display region 2203, and a processing button 2204.

The analysis button 2201 is a user interface for starting execution of template analysis in the chat column 2105 by the user operation.

The processing module pool display region 2202 is a region that displays the processing modules 12# in the processing module pool 102 by icons.

The template display region 2203 is a region that displays the processing modules 12# forming the template data 111 by icons.

The processing button 2204 is a user interface for instructing, by pressing, the structuring device 100 to start the structuring processing in the structuring processing unit 130 according to the template data 111 displayed in the template display region 2203.

An icon displayed in a shaded manner between the processing module pool display region 2202 and the template display region 2203 can be moved by drag-and-drop by the user operation.

### Presence Confirmation of Dependency Relationship

Next, presence confirmation of the dependency relationship between the processing modules 12# will be described. A user may not know how the dependency relationship between the processing modules 12# is. Therefore, the structuring device 100 can execute presence confirmation processing of the dependency relationship between the processing modules 12# after the execution of the extraction processing of the template data 111 performed by the classification unit 110 and before the execution of the structuring processing performed by the structuring processing unit 130.

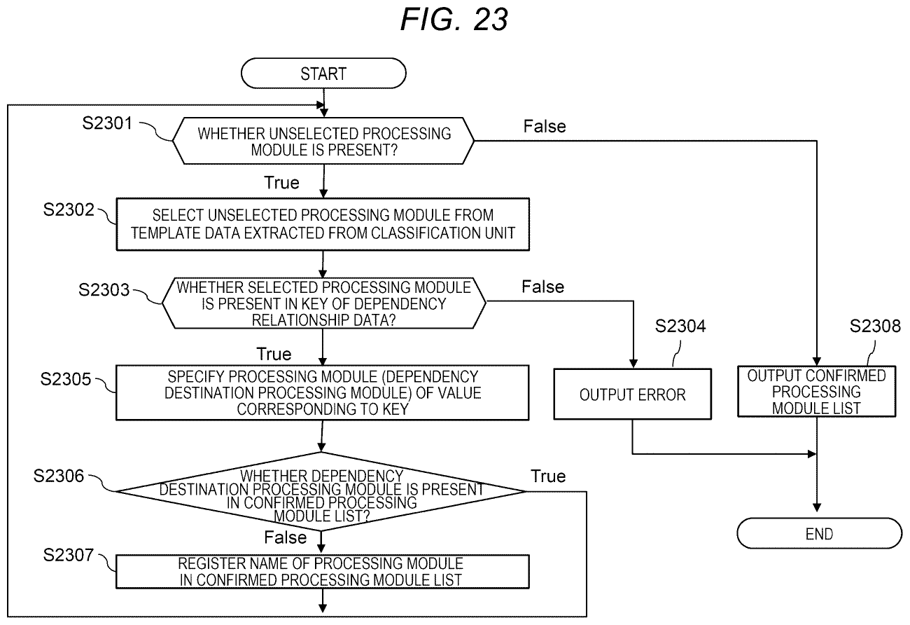

FIG. 23 is a flowchart showing an example of a confirmation processing procedure of the dependency relationship between the processing modules 12# by the structuring device 100 according to Embodiment 1. In an initial stage, an empty confirmed module list is prepared.

### Step S2301

The structuring device 100 determines whether an unselected processing module 12# is present in the template data 111. If step S2301 is false (step S2301: False), the processing proceeds to step S2308. If step S2301 is true (step S2301: True), the processing proceeds to step S2302.

### Step S2302

The structuring device 100 selects the unselected processing module 12# from the template data 111, and the processing proceeds to step S2303. For example, when none of the processing modules 12# is selected in the template data 1800 shown in FIG. 18, the structuring device 100 selects, for example, a leading data loading module 120.

### Step S2303

The structuring device 100 determines whether a selected processing module 12# in step S2302 is present in the key 1701 of the dependency relationship data 1700. When the selected processing module 12# is present in the key 1701, step S2301 is true (step S2303: True), and the processing proceeds to step S2305. When the selected processing module 12# is not present in the key 1701, step S2301 is false (step S2303: False), and the processing proceeds to step S2304.

### Step S2304

When the selected processing module 12# in the template data 111 is not present in the key 1701, the structuring device 100 cannot confirm that there is a dependency relationship between the processing modules 12#, and cannot execute the structuring processing based on the template data 111 by the structuring processing unit 130. Accordingly, the structuring device 100 outputs error information indicating that fact to the user in a visible manner. Accordingly, confirmation processing of the dependency relationship between the processing modules 12# ends.

### Step S2305

The structuring device 100 specifies a processing module 12# (hereinafter, dependency destination processing module 12#) of a value 1702 corresponding to the key 1701 in step S2303 from the dependency relationship data 1700, and the processing proceeds to step S2306.

### Step S2306

The structuring device 100 determines whether the dependency destination processing module 12# is present in a confirmed processing module list. If step S2306 is true (step S2306: True), the processing proceeds to step S2301. If step S2306 is false (step S2306: False), the processing proceeds to step S2307.

### Step S2307

The structuring device 100 registers a name of the dependency destination processing module 12# in the confirmed processing module list, and the processing returns to step S2301.

### Step S2308

The structuring device 100 outputs the confirmed processing module list to the user in a visible manner. Accordingly, the confirmation processing of the dependency relationship between the processing modules 12# ends.

### Hardware Configuration Example of Structuring Device 100

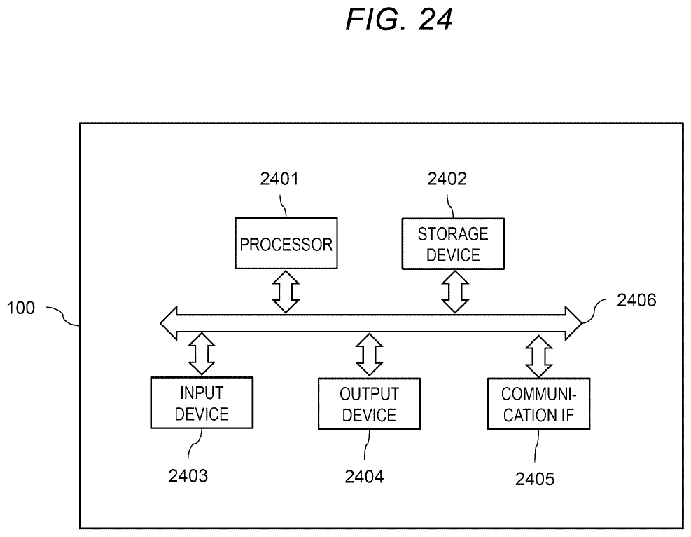

FIG. 24 is a block diagram showing a hardware configuration example of the structuring device 100 according to Embodiment 1. The structuring device 100 includes a processor 2401, a storage device 2402, an input device 2403, an output device 2404, and a communication interface (communication IF) 2405. The processor 2401, the storage device 2402, the input device 2403, the output device 2404, and the communication IF 2405 are connected to one another by a bus 2406. The processor 2401 controls the structuring device 100. The storage device 2402 is a work area of the processor 2401. The storage device 2402 is a non-transitory or transitory recording medium that stores various programs or data. Examples of the storage device 2402 include a read only memory (ROM), a random access memory (RAM), a hard disk drive (HDD), and a flash memory. The input device 2403 inputs data. Examples of the input device 2403 include a keyboard, a mouse, a touch panel, a numeric keypad, a scanner, a microphone, and a sensor. The output device 2404 outputs data. Examples of the output device 2404 include a display, a printer, and a speaker. The communication IF 2405 is connected to a network to transmit and receive data.

The structuring target document data 101, the processing module pool 102, the template data pool 103, the template classifier 104, the template data 111, and the structured data 131 shown in FIG. 1 are stored, for example, in the storage device 2402 of the structuring device 100 shown in FIG. 24 or in the storage device 2402 of another computer capable of communicating with the structuring device 100 via the network.

Functions of executing the processing module pool 102, the classification unit 110, and the structuring processing unit 130 shown in FIG. 1, and the confirmation processing shown in FIG. 23 are specifically implemented, for example, by causing the processor 2401 to execute the program stored in the storage device 2402 shown in FIG. 24.

As described above, according to Embodiment 1, the structuring target document data 101 can be structured with high accuracy according to the layout.

### Embodiment 2

Next, Embodiment 2 will be described. In Embodiment 1, the rule-based template classifier 104 is used. In Embodiment 2, a case where the template classifier 104 according to machine learning is used will be described. In Embodiment 2, since differences from Embodiment 1 will be mainly described, the same components as those in Embodiment 1 are denoted by the same signs, and the description thereof will be omitted.

### Functional Configuration Example of Structuring Device

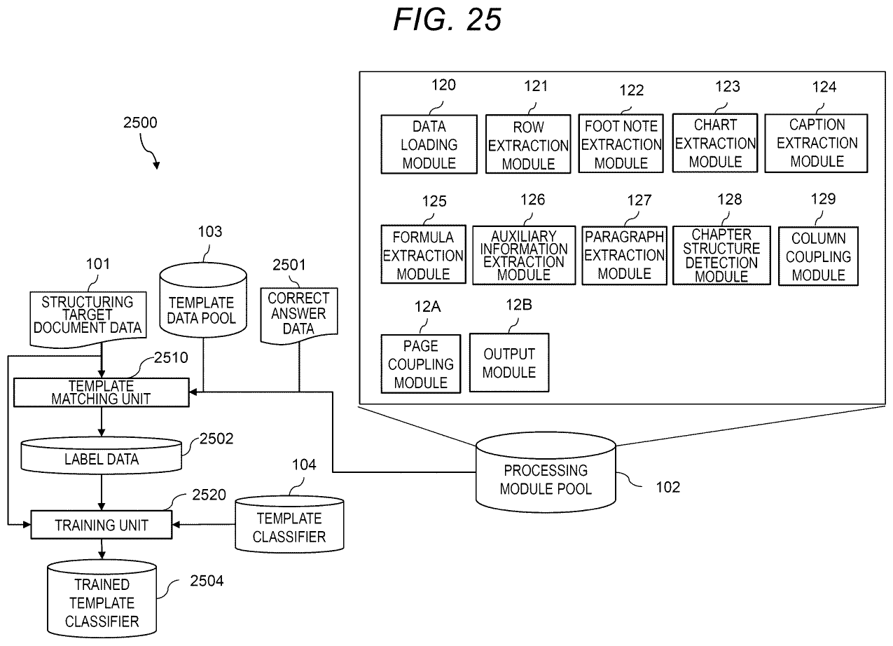

FIG. 25 is a block diagram showing a functional configuration example 1 of a structuring device according to Embodiment 2. A structuring device 2500 includes a template matching unit 2510 and a training unit 2520. The template matching unit 2510 receives the structuring target document data 101, the processing module pool 102, the template data pool 103, and correct answer data 2501, and outputs label data 2502.

The training unit 2520 receives the template data 111 and the template classifier 104, and outputs a trained template classifier 2504.

Specifically, the template matching unit 2510 and the training unit 2520 are implemented, for example, by causing the processor 2401 to execute the program stored in the storage device 2402 shown in FIG. 24. The correct answer data 2501 and the trained template classifier 2504 are stored in, for example, the storage device 2402 of the structuring device 100 shown in FIG. 24 or the storage device 2402 of another computer capable of communicating with the structuring device 100 via the network.

The correct answer data 2501 input to the template matching unit 2510 is structured data. Specifically, for example, as a result of creating template data by the user and inputting the structuring target document data 101 to the created template data, the correct answer data 2501 is structured data output by the structuring processing.

### Template Matching Unit 2510

Specifically, for example, the template matching unit 2510 executes the same structuring processing as that of the structuring processing unit 130 described in Embodiment 1 for each piece of template data (hereinafter, comparison target template data) in the template data pool 103, and generates structured data for each piece of the comparison target template data.

The template matching unit 2510 executes matching between each piece of the structured data generated for each piece of the comparison target template data and the correct answer data 2501, and determines a degree of matching. Specifically, for example, the template matching unit 2510 calculates, as a score, an edit difference between the correct answer data 2501 and the structured data obtained by performing the structuring processing on the structuring target document data 101 by each piece of the comparison target template data stored in the template data pool 103.

The score is calculated by an F value based on, for example, a matching degree of character units, a matching degree of row units, and a matching degree of paragraph units. After calculating the score, the template matching unit 2510 outputs the comparison target template data having the best score as the label data 2502.

### Training Unit 2520

The training unit 2520 receives the label data 2502, the structuring target document data 101, and the template classifier 104 according to machine learning, and outputs the trained template classifier 2504. Specifically, for example, the training unit 2520 trains the template classifier 104 according to machine learning based on a difference between the label data 2502 and an output result (template data) obtained as a result of inputting the structuring target document data 101 to the template classifier 104, and outputs the trained template classifier 2504.

At the time of training, since there is no selection input of the processing module 12# performed by the user operation, the training unit 2520 extracts the output result (template data) to be compared with the label data 2502 by selecting the processing module 12# in a round robin manner, as long as the dependency relationship is satisfied.

Since the template classifier 104 according to machine learning is a machine learning model, any architecture can be used. For example, a layout model LM based on a Transformer can be used.

The template classifier 104 extracts, for example, a feature related to a layout and a feature related to a character string from the structuring target document data 101, and optimizes the features as a multi-class classification problem of selecting an optimal template from the template data stored in the template data pool 103. Accordingly, in the training of the template classifier 104, a cross-entropy loss function is used.

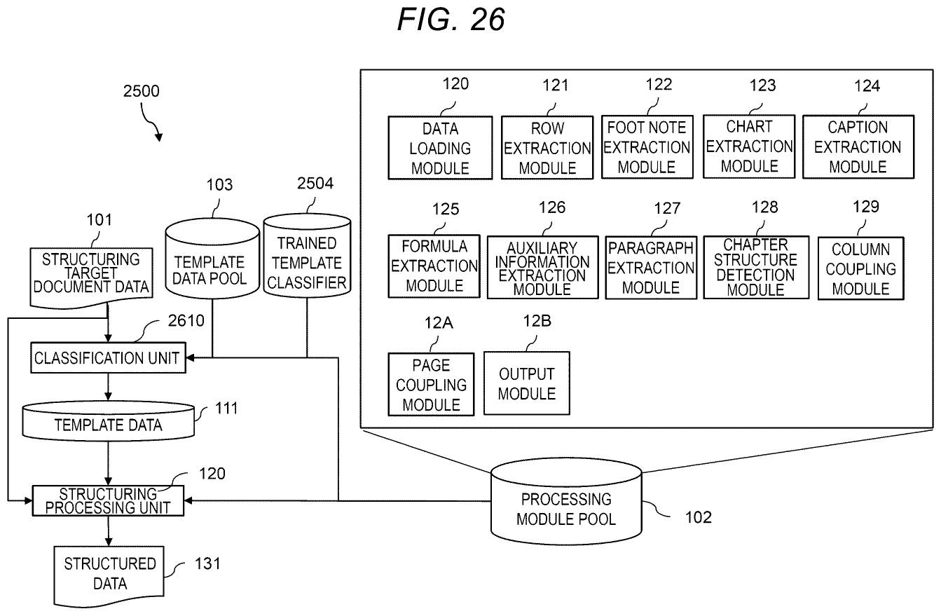

FIG. 26 is a block diagram showing a functional configuration example 2 of the structuring device 2500 according to Embodiment 2. The structuring device 2500 includes a classification unit 2610 and the structuring processing unit 130 in addition to the configuration shown in FIG. 25. Specifically, the classification unit 2610 is implemented, for example, by causing the processor 2401 to execute the program stored in the storage device 2402 shown in FIG. 24.

### Classification Unit 2610

The classification unit 2610 receives the structuring target document data 101, the processing module pool 102, the template data pool 103, and the trained template classifier 2504, and outputs the template data 111.

Specifically, for example, the classification unit 2610 inputs the structuring target document data 101 to the trained template classifier 2504, and selects the template data 111. That is, the trained template classifier 2504 selects, according to the multi-class classification problem, the optimal template data 111 from the template data considering all possible combinations considering the dependency relationship from the processing module pool 102. The classification unit 2610 extracts, from the template data pool 103, the template data 111 selected by the trained template classifier 2504.

### Setting Execution Screen

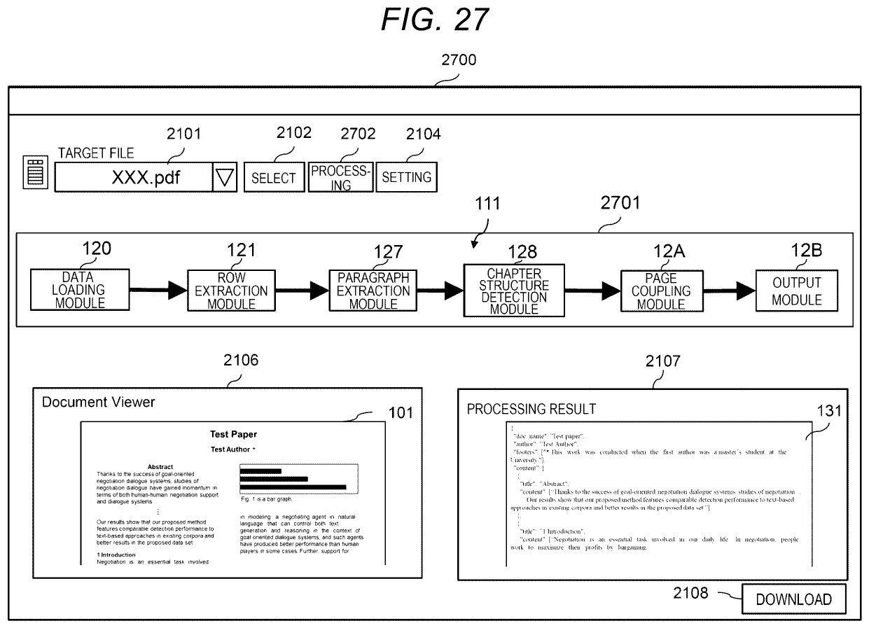

FIG. 27 is a diagram showing an example 1 of a setting execution screen according to Embodiment 2. A setting execution screen 2700 includes the target file selection region 2101, the select button 2102, the setting button 2104, the chat column 2105, the document file display region 2106, the structured data display region 2107, the download button 2108, a use template display region 2701, and a processing button 2702.

The processing button 2702 is a user interface that can start the structuring processing of the structuring target document data 101 by a user operation. The use template display region 2701 is a user interface that displays the template data 111 output when the classification unit 2610 is completed after the processing button 2702 is pressed by the user operation.

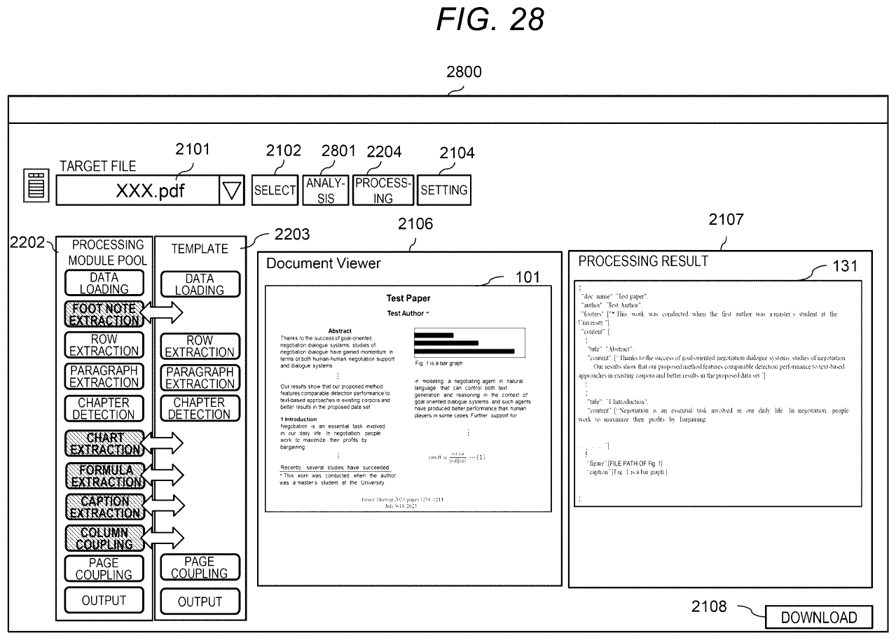

FIG. 28 is a diagram showing an example 2 of the setting execution screen according to Embodiment 2. A setting execution screen 2800 includes the target file selection region 2101, the select button 2102, the setting button 2104, the document file display region 2106, the structured data display region 2107, the download button 2108, the processing button 2204, an analysis button 2801, the processing module pool display region 2202, and the template display region 2203.

The analysis button 2801 is a user interface for instructing, by the user operation, the structuring device 2500 to start the extraction processing of the template data 111 in the classification unit 2610.

According to Embodiment 2, it is possible to automatically extract the optimal template data 111 according to the features of the structuring target document data 101, and to execute the structuring of the structuring target document data 101 with high accuracy.

The invention is not limited to the above embodiments, and includes various modifications and equivalent configurations within the scope of the appended claims. For example, the above embodiment is described in detail for easy understanding of the invention, and the invention is not necessarily limited to those including all the configurations described above. A part of a configuration of one embodiment may be replaced with a configuration of another embodiment. A configuration of one embodiment may also be added to a configuration of another embodiment. Another configuration may be added to a part of a configuration of each embodiment, and a part of the configuration of each embodiment may be deleted or replaced with another configuration.

A part or all of the above configurations, functions, processing units, processing methods, and the like may be implemented by hardware by, for example, designing with an integrated circuit, or may be implemented by software by, for example, a processor interpreting and executing a program for implementing each function.

Information on such as a program, a table, and a file for implementing each function can be stored in a storage device such as a memory, a hard disk, or a solid state drive (SSD), or in a recording medium such as an integrated circuit (IC) card, an SD card, or a digital versatile disc (DVD).

Control lines and information lines considered to be necessary for description are shown, and not all control lines and information lines necessary for implementation are shown. Actually, it may be considered that almost all the configurations are connected to one another.

What is claimed is:

1. A structuring device comprising:
a processor configured to execute a program; and
a storage device configured to store the program, wherein
a processing module pool that stores a plurality of processing modules capable of executing processing based on a feature related to a layout in document data, and a template data pool that stores template data in which two or more processing modules combined according to a dependency relationship among the plurality of processing modules are defined, are accessible, and
the processor executes
acquisition processing of acquiring structuring target document data,
extraction processing of extracting specific template data from the template data pool based on a result of a selection input of a feature related to a layout of the structuring target document data acquired by the acquisition processing, and
structuring processing of outputting first structured data in which the structuring target document data is structured by the feature related to the layout, by executing two or more specific processing modules forming the specific template data extracted by the extraction processing according to a dependency relationship among the two or more specific processing modules.

2. The structuring device according to claim 1, wherein
the plurality of processing modules include a first processing module essential for any template data and a second processing module which is selectable according to the selection input.

3. The structuring device according to claim 2, wherein
the first processing module includes a row extraction module that extracts a row element forming a row from the document data, a paragraph extraction module that extracts a paragraph element forming a paragraph based on the row element, and a detection module that detects whether the paragraph element corresponds to a heading, and
in the structuring processing, the processor generates the first structured data by distinguishing between a paragraph element corresponding to the heading and a paragraph element not corresponding to the heading based on a detection result of the detection module.

4. The structuring device according to claim 3, wherein
the first processing module includes a page coupling module that couples, based on the paragraph element, a leading paragraph element in a first page in the document data and a paragraph element at an end of a second page immediately preceding the first page, and
in the structuring processing, the processor generates the first structured data by distinguishing between the paragraph element corresponding to the heading and the paragraph element not corresponding to the heading based on the detection result of the detection module and a page coupling result of the page coupling module.

5. The structuring device according to claim 3, wherein
when two consecutive columns are present in the document data and two consecutive paragraph elements satisfy a predetermined condition, the first processing module includes a page coupling module that couples the two consecutive paragraph elements, and
in the structuring processing, the processor generates the first structured data by distinguishing between the paragraph element corresponding to the heading and the paragraph element not corresponding to the heading based on the detection result of the detection module and a page coupling result of the page coupling module.

6. The structuring device according to claim 1, wherein
a classifier that associates the feature related to the layout in the document data with the processing module is accessible, and
in the extraction processing, the processor extracts the specific template data by selecting the specific processing module corresponding to the result of the selection input using the classifier.

7. The structuring device according to claim 1, wherein
when the document data is input, a classifier trained to extract the template data from the template data pool based on the feature related to the layout in the document data is accessible, and
in the extraction processing, the processor extracts the specific template data by selecting the specific processing module corresponding to the result of the selection input using the classifier.

8. The structuring device according to claim 7, wherein
the processor executes
determination processing of determining a coincidence between second structured data corresponding to the structuring target document data and third structured data for each piece of template data obtained by executing the structuring processing on the structuring target document data for each piece of the template data in the template data pool, and outputting, as label data, the template data which is a generation source of the second structured data based on a determination result, and
training processing of training the classifier based on the template data obtained by inputting the structuring target document data to the classifier and the label data outputted by the determination processing, and
in the extraction processing, the processor extracts the specific template data by selecting the specific processing module corresponding to the result of the selection input using the classifier trained by the training processing.

9. A structuring method executed by a structuring device including a processor that executes a program and a storage device that stores the program, wherein
a processing module pool that stores a plurality of processing modules capable of executing processing based on a feature related to a layout in document data, and a template data pool that stores template data in which two or more processing modules combined according to a dependency relationship among the plurality of processing modules are defined, are accessible, and
the processor executes
acquisition processing of acquiring structuring target document data,
extraction processing of extracting specific template data from the template data pool based on a result of a selection input of a feature related to a layout of the structuring target document data acquired by the acquisition processing, and
structuring processing of outputting first structured data in which the structuring target document data is structured by the feature related to the layout, by executing two or more specific processing modules forming the specific template data extracted by the extraction processing according to a dependency relationship among the two or more specific processing modules.

10. A structuring program that causes a processor capable of accessing a processing module pool that stores a plurality of processing modules capable of executing processing based on a feature related to a layout in document data, and a template data pool that stores template data in which two or more processing modules combined according to a dependency relationship among the plurality of processing modules are defined, to execute:
acquisition processing of acquiring structuring target document data;
extraction processing of extracting specific template data from the template data pool based on a result of a selection input of a feature related to a layout of the structuring target document data acquired by the acquisition processing; and
structuring processing of outputting first structured data in which the structuring target document data is structured by the feature related to the layout, by executing two or more specific processing modules forming the specific template data extracted by the extraction processing according to a dependency relationship among the two or more specific processing modules.
